(19) United States
(12) Patent Application Publication
(10) Pub. No.: US 2026/0054218 A1
(43) Pub. Date: Feb. 26, 2026

(54) SEPARATION OF CARBON DIOXIDE AND OTHER ACID GASES FROM FLUE GAS USING PHYSICAL SOLVENTS AND ALKALI

(71) Applicants: Mark T. Holtzapple, College Station, TX (US); Jonathan Jay Feinstein, Bridgeport, CT (US)

(72) Inventors: Mark T. Holtzapple, College Station, TX (US); Jonathan Jay Feinstein, Bridgeport, CT (US)

(21) Appl. No.: 19/312,191

(22) Filed: Aug. 27, 2025

Related U.S. Application Data
(63) Continuation-in-part of application No. PCT/US2024/027347, filed on May 2, 2024.
(63) Continuation-in-part of application No. 19/006,203, filed on Dec. 30, 2024.
Application No. 19/006,203 is a continuation of application No. 17/558,903, filed on Dec. 22, 2021, now Pat. No. 12,179,145.
(60) Provisional application No. 63/132,148, filed on Dec. 30, 2020.
(60) Provisional application No. 63/463,381, filed on May 2, 2023.
(60) Provisional application No. 63/687,439, filed on Aug. 27, 2024.
(60) Provisional application No. 63/729,393, filed on Dec. 8, 2024.
(60) Provisional application No. 63/847,292, filed on Jul. 20, 2025.

(51) Int. Cl. B01D 53/75; B01D 53/02; B01D 53/14

(52) U.S. Cl. CPC B01D 53/75; B01D 53/02; B01D 53/1431; B01D 2252/205; B01D 2253/106; B01D 2257/302; B01D 2257/404; B01D 2257/504; B01D 2258/0283

(57) ABSTRACT

Flue gas is compressed to high pressures, which raises the partial pressure of carbon dioxide thus facilitating its absorption into physical solvents (e.g., water, salt solutions, methanol). When added onto an existing CO₂-producing process, the compression is performed using multiple stages with intercooling. After the high-pressure carbon dioxide dissolves into the physical solvent, it flows through a series of pressure letdowns using turbines that allow the dissolved carbon dioxide to evolve from the solvent. Through a series of multiple compression stages, the evolved gas is compressed for transport, utilization, or storage. The flue gas that has been scrubbed of carbon dioxide flows through a series of expanders with interheating supplied from waste heat, or the heat of compression. The process is enhanced by employing alkalis that chemically react with acid gases, such as carbon dioxide. These same CO₂-capture processes can be integrated into processes that produce shaft and/or electrical power.

### CROSS-REFERENCE TO RELATED APPLICATIONS

This application claims priority to U.S. Provisional Patent Application No. 63/687,439 filed on Aug. 27, 2024, entitled “HEAT ENGINE WITH PRE-EXPANSION CARBON CAPTURE FOR SOLID FUELS”; U.S. Provisional Patent Application No. 63/847,292 filed on Jul. 20, 2025, entitled “COGENERATION OF LOW CARBON SYNGAS AND POWER”; and U.S. Provisional Patent Application No. 63/729,393 filed on Dec. 8, 2024, entitled “CARBON DIOXIDE CAPTURE FROM HOT EFFLUENT.” This application is also a continuation-in-part of PCT Patent Application No. PCT/US2024/027347 filed on May 2, 2024, entitled “ENGINE WITH POST COMBUSTION PRE-EXPANSION CARBON CAPTURE,” which claims priority to U.S. Provisional Patent Application No. 63/463,381, filed on May 2, 2023, entitled “ENGINE WITH PRE-EXPANSION CARBON CAPTURE.” Additionally, this application is a continuation-in-part of U.S. patent application Ser. No. 19/006,203 filed Dec. 30, 2024, entitled “CRYOGENIC SEPARATION OF CARBON DIOXIDE, SULFUR OXIDES, AND NITROGEN OXIDES FROM FLUE GAS,” which is a continuation of U.S. patent application Ser. No. 17/558,903 filed Dec. 22, 2021, now US Patent No. 12/179,145 issued Dec. 31, 2024, which claims priority to U.S. Provisional Patent Application No. 63/132,148 filed Dec. 30, 2020. The present application claims priority to each of these applications. Additionally, each of these applications is hereby incorporated by reference in its entirety.

### TECHNICAL FIELD

This invention relates to gas capture techniques and more particularly to a separation of carbon dioxide and other acidic gases from flue gas using physical solvents and alkali.

### BACKGROUND

Global warming is caused by the accumulation of greenhouse gases in the atmosphere. The dominant greenhouse gas is carbon dioxide, most of which is produced by combusting fossil fuels. The majority of fossil fuel combustion occurs in large central facilities such as power plants, refineries, factories, cement kilns, lime kilns, steel mills, etc. Economic recovery of carbon dioxide from flue gas emitted from large central facilities would contribute greatly to the reduction of global warming.

Methods for recovering carbon dioxide from flue gas include chemical absorption into liquids (e.g., amines), physical absorption into liquids (e.g., methanol), adsorption onto solids (e.g., mesoporous silicas, zeolites, and metal-organic frameworks), membranes, reaction with alkalis (e.g., lime), and cryogenics.

This invention employs two methods: (1) physical absorption into liquid, and (2) reaction with alkalis.

### SUMMARY

In an embodiment of the disclosure, a method of performing work on a load involves combusting a fuel containing carbon and an oxidant in a combustion device to form gaseous combustion products having a temperature and a pressure. The temperature and/or pressure of these gaseous combustion products is then adjusted to a level suitable for separation, such as by cooling the products to a suitable temperature or compressing them to a suitable pressure. Following adjustment, the gaseous combustion products are separated into a carbon dioxide-rich stream and a carbon dioxide-poor stream, with the carbon dioxide-poor stream having its own temperature and pressure. The carbon dioxide-poor stream is subsequently heated to a temperature suitable for expansion and expanded against the load to perform work.

In further aspects of this embodiment, the cooling of the gaseous combustion products may occur via heat exchange against the carbon dioxide-rich stream and/or the carbon dioxide-poor stream, potentially within the combustion device itself. Additionally, the oxidant and/or fuel can be preheated by heat exchange against the expanded gas from the expansion step. In combustors, the fuel may include coal, biomass, gaseous fuels, or those containing oxides of carbon such as carbon monoxide, sourced from effluents like those from blast furnaces, oil refineries, steam methane reformers, chemical production processes, or treatment plants. In the combustors, the oxidant is typically oxygen contained within air; however, the air may be enriched in oxygen to reduce diluting components such as nitrogen. Separation of the gaseous combustion products can be achieved by dissolving carbon dioxide in a solvent, such as water or methanol. In another variation, the gaseous combustion products are cooled against a second gas at a pressure suitable for expansion, heating that second gas for subsequent expansion against the load.

In another embodiment of the disclosure, a heat engine comprises a compressor configured to compress the oxidant inducted into the engine and/or the gaseous combustion products; a combustion device to combust the oxidant with a carbon-containing fuel, producing gaseous combustion products containing carbon dioxide; a carbon dioxide separator to divide these products into a carbon dioxide-rich stream and a carbon dioxide-poor stream; and an expander to expand the carbon dioxide-poor stream. The heat engine may further include a cooling device for the gaseous combustion products, a heating device for the carbon dioxide-poor and/or carbon dioxide-rich streams, and a heat exchanger to transfer heat from the expanded stream to the oxidant and/or fuel.

In yet another embodiment of the disclosure, a method of performing work on a load includes cooling an effluent from a first process—where the effluent has a first pressure and a first temperature greater than 150° C. (or greater than 250° C.)—to a second temperature lower than the first. The cooled effluent is then compressed to a second pressure greater than the first (such as greater than 40 bar) to create an expansion gas, which is reheated against the original effluent and expanded against the load. In particular embodiments, the expansion gas is separated into a carbon dioxide-rich gas and a carbon dioxide-poor gas, with the carbon dioxide-poor gas heated against the effluent and expanded. This separation may involve absorbing carbon dioxide into a solvent like water, an aqueous solution, Rectisol, Selexol, or potassium carbonate.

While the embodiments described herein may provide certain advantages, such as improved efficiency, enhanced carbon capture, or adaptability to various fuels and oxidants, it is to be understood that not all embodiments of the disclosure necessarily achieve all such advantages, and the scope of the invention is not limited to embodiments that realize these or any other benefits. The full scope of the invention is defined by the claims.

### BRIEF DESCRIPTION OF DRAWINGS

For a more complete understanding of this disclosure and its features, reference is now made to the following description, taken in conjunction with the accompanying drawings in which:

FIG. 1 shows Henry's constant for water and methanol as a function of temperature.

FIG. 2 shows a simple schematic of an absorption column.

FIGS. 3A, 3B and 3C show profiles of the partial pressure of carbon dioxide along the height of the absorption column.

FIG. 4 shows Option A-1 where high-pressure flue gas is scrubbed of carbon dioxide in an absorption column using water.

FIG. 5 shows Option A-2 where high-pressure flue gas is chilled using refrigeration and is scrubbed of carbon dioxide in an absorption column using water.

FIG. 6 shows Option A-3 where high-pressure flue gas is chilled using gas expansion and is scrubbed of carbon dioxide in an absorption column using water.

FIG. 7 shows multi-stage compression using axial fans and intercooling.

FIG. 8 shows multi-stage expansion using axial turbines and interheating.

FIGS. 9A and 9B show the layout for axial fans arranged as compressors and expanders.

FIGS. 10A, 10B, and 10C show three methods for promoting carbon dioxide nucleation.

FIG. 11 shows Option B where high-pressure flue gas is scrubbed of carbon dioxide in a series of agitated vessels using water.

FIG. 12 shows Option C where regeneration of the physical solvent is enhanced by raising its temperature.

FIG. 13 shows Option D-1 where recovery is enhanced by adding divalent alkalis to the circulating water at ambient pressure.

FIG. 14 shows Option D-2 where recovery is enhanced by adding divalent alkalis to the circulating water at elevated pressure.

FIG. 15 shows Option E where a second absorption column is added to remove other acids gases (e.g., SOₓ) from the flue gas.

FIG. 16 shows Option F where recovery is enhanced by incorporating monovalent and divalent alkalis.

FIG. 17 shows Option G where recovery is enhanced by utilizing electrochemical

water-splitting bipolar electrodialysis.

FIG. 18 shows details of electrochemical water-splitting bipolar electrodialysis.

FIG. 19 shows Option H, which employs a physical solvent other than water.

FIG. 20 shows a biological filter.

FIG. 21 shows Option I-1, which integrates carbon capture into a power-production process that approximates the Ericsson cycle and uses air-rich combustion.

FIG. 22 shows Option I-2, which integrates carbon capture into a power-production process that approximates the Ericsson cycle and uses fuel-rich combustion.

FIG. 23 shows the per-stage enthalpy change in expanders with a pressure ratio of 2.

FIG. 24 shows Option I-3, which employs recycle to achieve stoichiometric combustion.

FIG. 25 shows Option I-4, which employs a single combustor rather than a series of combustors.

FIG. 26 shows Option I-5, which replaces the compression train with high-pressure liquid water.

FIG. 27 shows Option I-6, which employs serial ambient-pressure combustion with parallel extraction of heat.

FIG. 28 shows Option I-7, which employs serial high-pressure combustion with parallel extraction of heat.

FIG. 29 shows Option I-8, which employs multiple series of combustors, each operating at successively higher pressures.

FIG. 30 shows Option I-9, which employs multiple series of combustors, each operating at successively higher pressures. The first combustor operates at ambient pressure.

FIG. 31 shows Option J-1, which integrates carbon capture into a recuperated Brayton power-production process and uses liquid or gaseous fuels.

FIG. 32 shows Option J-2, which integrates carbon capture into a recuperated Brayton power-production process and uses a lock hopper to introduce solid fuels into the combustor.

FIG. 33 shows Option J-3, which integrates carbon capture into a recuperated Brayton power-production process and uses a lock hopper to introduce solid fuels into a gasifier.

FIG. 34 shows Option K, which integrates carbon capture into a recuperated Brayton power-production process that employes near-isothermal compression.

FIG. 35 shows Option L-1, which integrates carbon capture into a power-production process that includes a methane reformer to produce hydrogen. The combustor operates at elevated pressure.

FIG. 36 shows Option L-2, which integrates carbon capture into a power-production process that includes a methane reformer to produce hydrogen. The combustor operates at near-ambient pressure.

FIG. 37 shows Option L-3, which integrates carbon capture into a power-production process that includes a methane reformer to produce hydrogen and carbon monoxide. The combustor operates at elevated pressure.

FIG. 38 shows Option L-4, which integrates carbon capture into a power-production process that includes a methane reformer to produce hydrogen and carbon monoxide. The combustor operates at near-ambient pressure.

FIG. 39 shows how ammonia production integrates with processes that capture CO₂ and produce electricity.

FIG. 40 shows how liquid fuel production integrates with processes that capture CO₂ and produce electricity.

FIG. 41 shows Option M-1, which employs a combined-cycle gas turbine that employs exhaust gas recirculation. A portion of the high-pressure combustion gas is removed from an intermediate stage of the expander so that carbon dioxide is recovered.

FIG. 42 shows Option M-2, which is identical to Option M-1, except that an additional compression stage is added prior to the absorber.

FIG. 43 shows Option M-3, which is identical to Option M-2, except that the air fed to the combined-cycle gas turbine is enriched in oxygen.

FIG. 44 shows the concentration of carbon dioxide in the flue gas based on the percentage of oxygen in the feed air.

FIG. 45 shows the energy requirements for increasing the oxygen concentration in feed air.

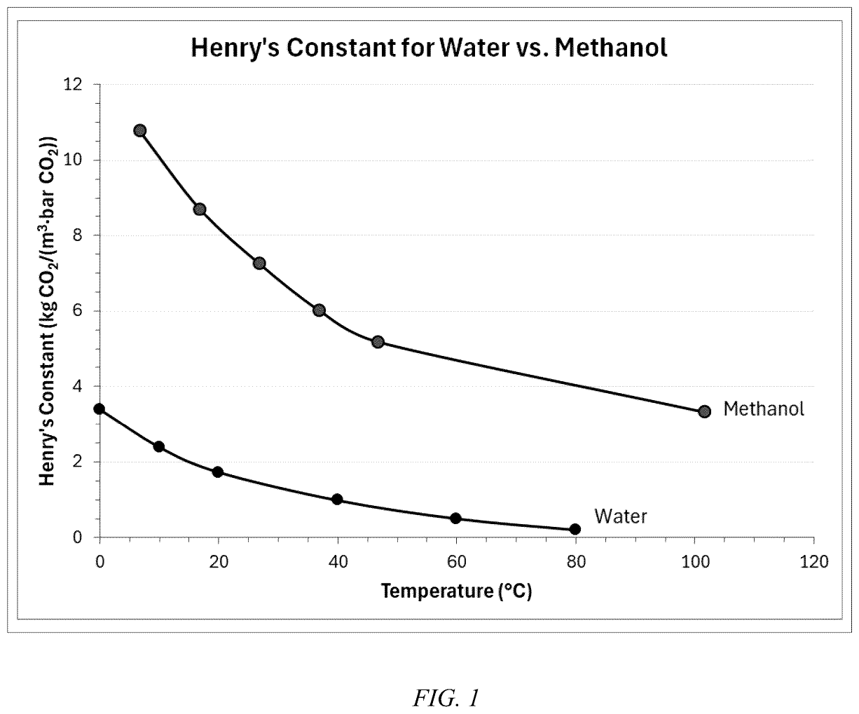

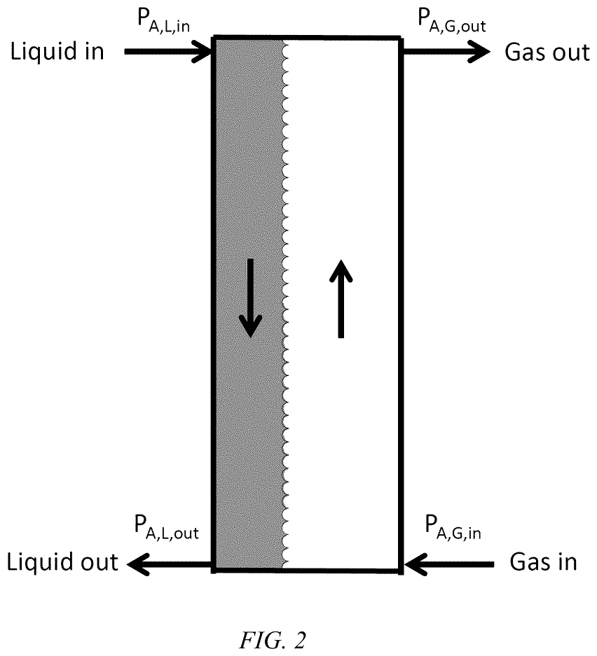

Throughout the drawings, like reference numerals denote corresponding or similar elements, with numerals in different figures incremented to reflect the figure or embodiment (e.g., element 123 in FIG. 1 generally corresponds to element 223 in FIG. 2). However, such corresponding elements may differ in specific aspects to accommodate changes in the overall system configuration.

### DETAILED DESCRIPTION

The figures described below, and the various embodiments used to describe the principles of the present disclosure in this patent document, are by way of illustration only and should not be construed in any way to limit the scope of the disclosure. Those skilled in the art will understand that the principles of the present disclosure invention may be implemented in any suitably arranged device or system. Additionally, the drawings are not necessarily drawn to scale.

### Theory

Physical absorption of carbon dioxide into a liquid is characterized by Henry's Law, which is commonly expressed by the following two formulas:

$${P}_{A} = H ’ {x}_{A} \qquad ( 1 )$$

$${c}_{A} = H {P}_{A} \qquad ( 2 )$$

where
P_{A}=Partial pressure of Species A (i.e., carbon dioxide)
x_{A}=Mole fraction of Species A (i.e., carbon dioxide)
c_{A}=Concentration of Species A (i.e., carbon dioxide)
H′=Henry's constant for Equation 1
H=Henry's constant for Equation 2

FIG. 1 shows the Henry's constant H for carbon dioxide dissolved in water and methanol as a function of temperature. Generally, the Henry's constant for methanol is about 4 times larger than water. Methanol is often a preferred solvent for removing carbon dioxide from industrial gases, the Rectisol process being the most famous example. For both solvents, Henry's constant decreases as temperature increases.

FIG. 2 shows a simplified description of a column where liquid flows from the top down and gas flows from the bottom up. At any location along the vertical height, the partial pressure of carbon dioxide in the gas phase is greater than the partial pressure in the liquid phase. This difference in partial pressure (chemical potential) causes carbon dioxide to flow from the gas phase into the liquid phase.

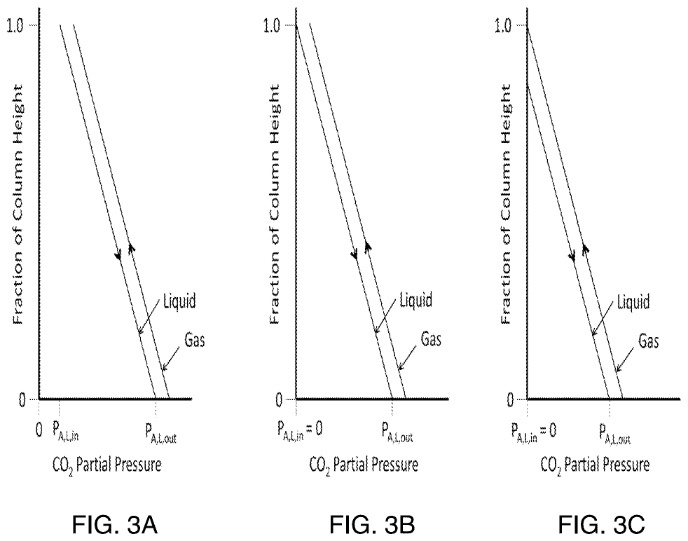

FIG. 3 shows the partial pressure profile of Species A (carbon dioxide) in the liquid and gas phases at each elevation in the column. As described above, at every height, the partial pressure of Species A (carbon dioxide) is greater in the gas phase than the liquid phase, which drives carbon dioxide to dissolve in the liquid phase.

The following processes employ both compressors and expanders. It is understood that compressors require an input of shaft power and expanders produce an output of shaft power. The expanders can drive the compressors directly. Alternatively, if excess shaft power is available from the expanders, it can be used to drive a generator that produces electricity. Because the shaft power from the expander can be employed in two manners, for simplicity, the coupling to a compressor or generator is not shown. It is understood that this shaft power can be employed in either applications.

### Add-On CO₂-Capture Processes

Add-on CO₂-capture processes remove carbon dioxide from the flue gas emitted by existing processes, such as power plants, chemical plants, refineries, cement kilns, lime kilns, steel mills, etc.

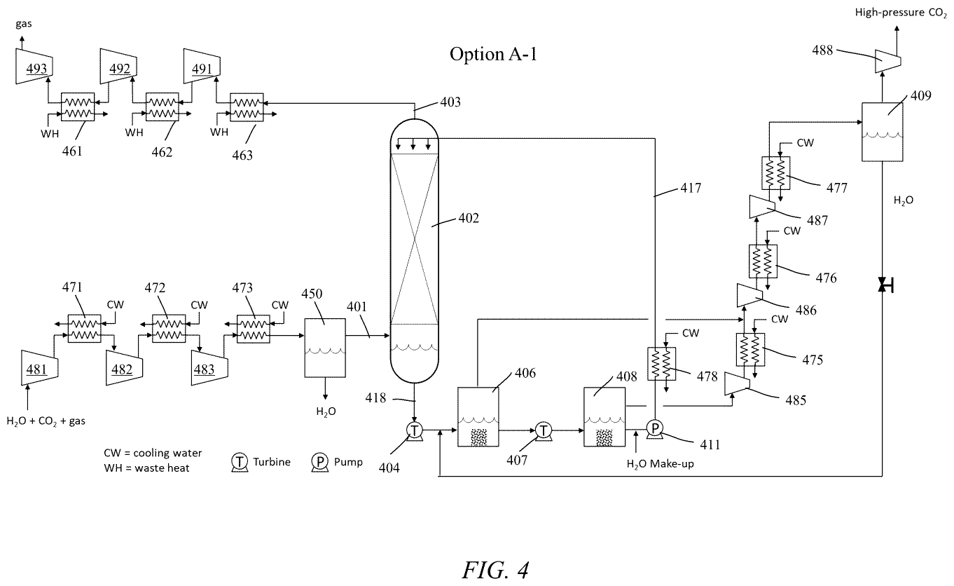

FIG. 4 shows Option A-1, according to an embodiment of the disclosure. Flue gas containing water vapor, carbon dioxide, and gases (e.g., nitrogen, oxygen, argon) has been cooled to near-ambient temperature. Then, through a series of compression stages (compressors 481, 482, 483) with intercoolers (heat exchangers 471, 472, 473), the pressure rises. The intercoolers keep the gas at near-ambient temperature, which reduces energy requirements in the compressors.

As shown in FIG. 4, as the flue gas is compressed and intercooled, water condenses and is removed from the system (e.g., as shown by the water outlet from vessel 450). The high-pressure flue gas enters 401 a packed column 402 at the bottom while high-pressure water enters 417 at the top. The water entering at the top has a low concentration of dissolved carbon dioxide. As it flows down column 402, it absorbs carbon dioxide from the flue gas, which enters 401 at the bottom.

The water exiting 418 from the bottom of the column 402 has dissolved carbon dioxide, which is nearly saturated at the partial pressure of carbon dioxide in the raw flue gas. This high-pressure liquid flows through a series of pressure-let down devices that reduce the pressure and thereby allows the dissolved carbon dioxide to enter the gas phase. Non-limiting examples of pressure-letdown devices include Pelton wheel, Francis turbine, Turgo turbine, centrifugal turbines, radial expanders, axial pistons, radial pistons, gear motors, vane motors, gerotors, and isobaric pressure exchangers. In some cases, these devices are used to recover pressure from discharged brine in reverse osmosis systems. In FIG. 4, the pressure-letdown devices are shown as turbines 404, 407. While two are shown, more or fewer than two may be utilized.

To facilitate bubble nucleation in vessels 406 and 408, a porous surface is employed, such as sintered metal, zeolite, sand, etc. At each pressure letdown stage, the evolved carbon dioxide is fed to the inlet of a multi-stage compressor train (e.g., compressors 485, 486, 487). To maximize efficiency, the compressor inlet pressure matches the pressure of the evolved carbon dioxide. As shown, as the total pressure of CO₂ increases, liquid water will condense when interstage cooling (e.g., heat exchangers 475, 476, and 477) is employed. This condensed water contains dissolved CO₂, so it is recycled so that the CO₂ can be captured as shown by the outlet from vessel 409. From the vessel 409, the CO₂ may be compressed, again, via compressor 488 to yield the high-pressure CO₂. Because liquid water and CO₂ forms carbonic acid, the intercoolers must be constructed from expensive acid-resistant materials. Alternatively, to avoid this cost, the CO₂ can be dried to remove water prior to compression. Typical drying agents include silica gel, zeolites, activated alumina, and calcium sulfate. Once the drying agent is saturated, it is regenerated by swinging the temperature or pressure. Such processes are common and typically employ two beds, one that is actively drying and the other is being regenerated.

As the carbon dioxide bubbles emerge from the saturated liquid, there is a slight cooling effect. Under standard conditions, the enthalpies of formation for gaseous and aqueous CO₂ follow:

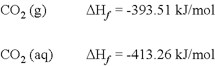

The evolution of CO₂ from water into the gas phase is represented by the following equation:

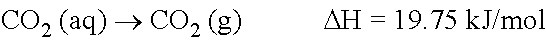

The positive enthalpy change indicates that cooling occurs when carbon dioxide evolves from the liquid phase to the gas phase. Additional cooling results from the evaporation of water that occurs simultaneously with the evolution of the gaseous carbon dioxide from the liquid phase.

After the final letdown stage, the water is pumped (e.g., via pump 411) to high pressures and is returned to the absorption column 402 through line 417. If necessary, the water exiting the pumps is cooled (e.g., via heat exchanger 478) to maintain near-ambient temperature.

The gas exiting 403 the absorption column 402 has a reduced content of carbon dioxide and is sent to a series of expanders (491, 492, 491) that reduce the pressure. Between the stages, interheating (e.g., via heat exchangers 461, 462, and 463) is employed. The source of heat could be from the heat of compression in the compression train; however, flue gas is typically accompanied by large volumes of low-grade waste heat. To maximize power production, the gas between each expansion stage is heated to the highest possible temperatures using waste heat.

In the compression and expansion trains of FIG. 4 (and other embodiments described herein), a variety of heat exchangers could be employed such as, but not limited to, plate-and-frame, shell-and-tube, finned-tube, plate-finned, direct-contact, etc. The incoming and outgoing flue gas can exchange heat with water, air, flue gas, or other fluids.

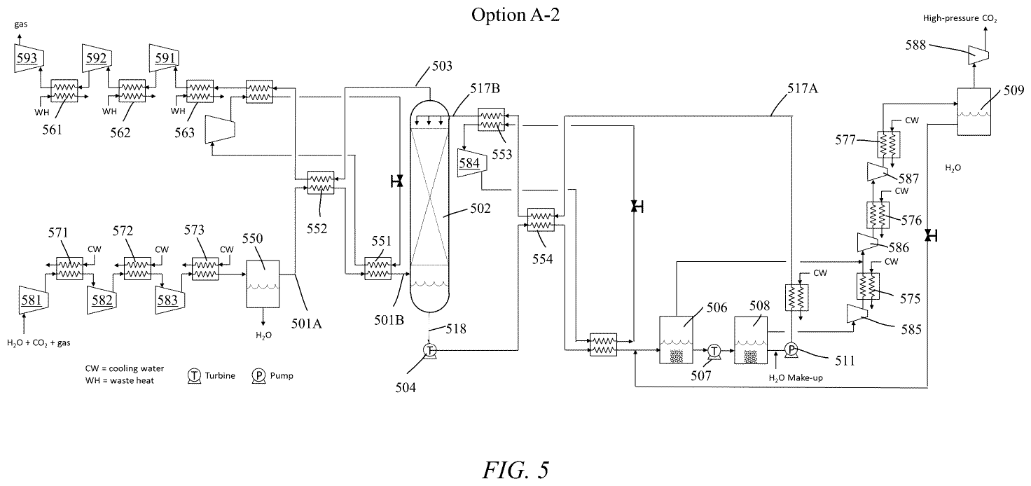

FIG. 5 shows Option A-2, according to an embodiment of the disclosure. Option A-2 is similar to Option A-1 except that the flue gas and water entering (501B, 517B) the absorption column 502 are precooled to lower the temperature and thereby increase Henry's constant (FIG. 1). The impact of lower temperatures is to reduce the water circulation rate, which decreases the size of the absorption columns and also reduces pumping power.

In FIG. 5, most of the precooling occurs through countercurrent heat exchangers (551, 552, 553, 554); however, because of the required approach temperature in the heat exchangers, complete heat exchange is not possible. To overcome this problem, a heat pump is employed to remove heat from the incoming stream and discharge it to the outgoing stream.

To lower the temperature at which absorption occurs, agents can be added to the water, which lowers the freezing point. Examples of candidate agents follow:
Calcium chloride
Magnesium chloride
Sodium acetate
Potassium acetate
Ethylene glycol
Propylene glycol

To reduce corrosion, the following additives are examples:
Sodium nitrite
Sodium molybdate
Sodium phosphates

They may be used in pure form, or as mixtures.

It should be noted that adding agents to water typically lowers the solubility of CO₂ at a given temperature through the so-called salting-out effect. On the other hand, lowering the temperature improves the solubility of CO₂. Specific combinations of chemistry, concentration, and temperature can yield improved loading of CO₂ in aqueous systems. Many of these additives are nonvolatile and will not be released into the environment. Furthermore, many of them are inexpensive and readily available.

The water 518 and 517B that circulates through absorption column 502 and vessels 506 and 508 has constant addition of energy from liquid pumps 511 and the heat pump compressor 584. Typically, in a single pass through the system, the circulating water would increase in temperature by about 0.63° C. If this energy is not removed, upon each circulation, the water temperature will increase further. To remove this energy, multiple approaches may be taken.

In Approach 1, the water circulating through vessels 506 and 508 has sufficiently high temperature that the energy can be rejected directly to cooling water or air through conventional heat exchangers, such as plate-and-frame, shell-and-tube, air-cooled fins, etc. This approach has the advantage of simplicity; however, the operating temperature may be so high that the heat duty on heat exchanger 554 may be excessive and expensive.

In Approach 2, the circulating water is cooled by a heat exchanger that rejects heat to a cold fluid, such as an evaporating refrigerant or chilled water. In Approach 2, the circulating water operates at a lower temperature than Approach 1 and therefore reduces the heat duty on heat exchanger 554, but it has an additional expense of a refrigeration system.

In Approach 3, the circulating water is cooled by operating vessel 508 at sufficiently low pressure that a portion of the circulating water evaporates and thereby cools the circulating water. For example, to cool the circulating water by 0.63° C., it is necessary to evaporate 1.08 kg of water per m³ of circulating water. At 25° C., the vapor pressure of water is 0.0317 bar. Assume that vessel 508 operates with a water vapor pressure of 0.0317 bar and that the water entering vessel 508 is 25.63° C. In this scenario, a portion of the water entering vessel 508 (1.08 kg of water per m³) will evaporate and thereby cool the liquid water exiting vessel 508 to 25° C. At this low pressure, dissolved CO₂ will bubble out of the water and thereby achieve extremely high CO₂ recovery. For example, if vessel 508 were to operate at a total pressure of 0.0427 bar, the gas phase would be 74 mol % water and 26 mol % CO₂. Because the CO₂ partial pressure is so low (0.0111 bar), the dissolved CO₂ in returned water 517B is extremely low (0.0165 kg CO₂/m³ water). In this example, assume that absorber 502 operates at 0° C., total pressure 18 bar, and incoming gas 501B contains 15 mol % CO₂. At equilibrium, the CO₂ concentration in water stream 518 is 9.12 kg CO₂/m³ water. In this scenario, comparing the CO₂ concentrations in water streams 518 and 517B, the total CO₂ recovery is about 99.8%. Approach 3 achieves both cooling and extraordinarily high CO₂ recovery. The low pressures in vessel 508 is achieved by compressor 585. Examples of such compressors include turbo compressors, lobe compressors (Roots blowers), gerotor compressors, liquid-ring vacuum pumps, jet ejectors, and other suitable devices.

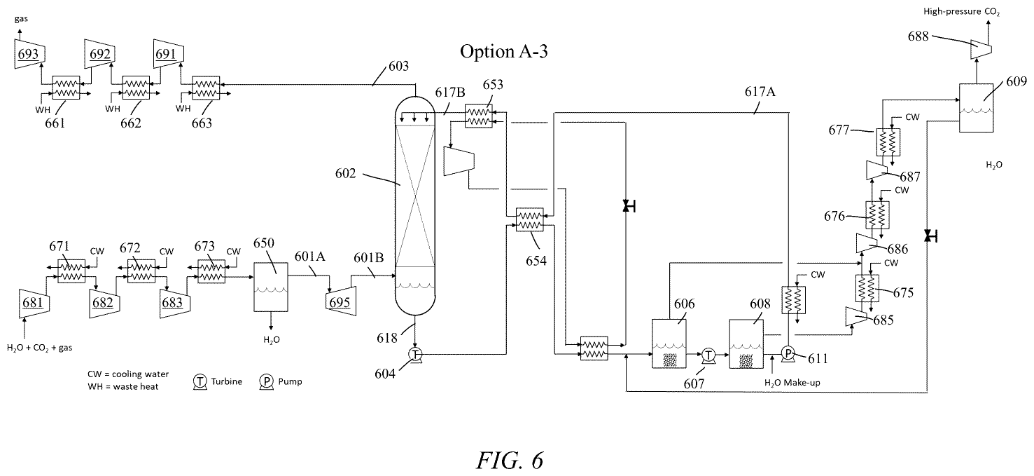

FIG. 6 shows Option A-3, according to another embodiment of the disclosure. Option A-3 which is similar to Option A-2 except that the flue gas is cooled by an expander 695.

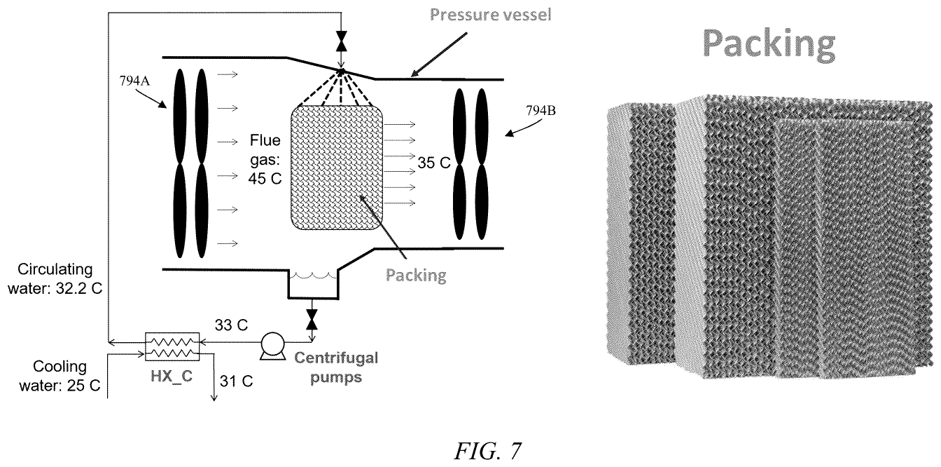

In many applications, the volume of flue gas is large, so conventional compressors may be too expensive. To overcome this problem, compression can occur using a series of mining fans, or similar axial fans (FIG. 7). This type of fan is characterized by having a tip speed of about Mach 0.5. Interstage cooling can be achieved using direct contact of the compressed flue gas with wetted packing, such as Munters CELdek packing, structured packing typically employed in cooling towers (e.g., Brentwood Industries), or even dump packing. FIG. 7 shows typical temperatures that result from cooling the circulating water against cooling water.

As shown in FIG. 7, the wetted packing has horizontal channels; however, this arrangement makes it difficult to countercurrently flow of water and gas. By arranging the channels vertically, it is more practical to achieve countercurrent flow: water flows downward and gas flows upward.

In FIG. 7, the use of wetted-packing, direct-contact heat exchange is shown in the context of cooling the flue gas; however, this same concept can be applied throughout the process whenever compressed gas must be cooled. Because of direct-contact heat transfer and the inexpensive wetted packing, this approach to heat transfer is substantially less expensive than conventional gas-to-air or gas-to-liquid heat exchangers.

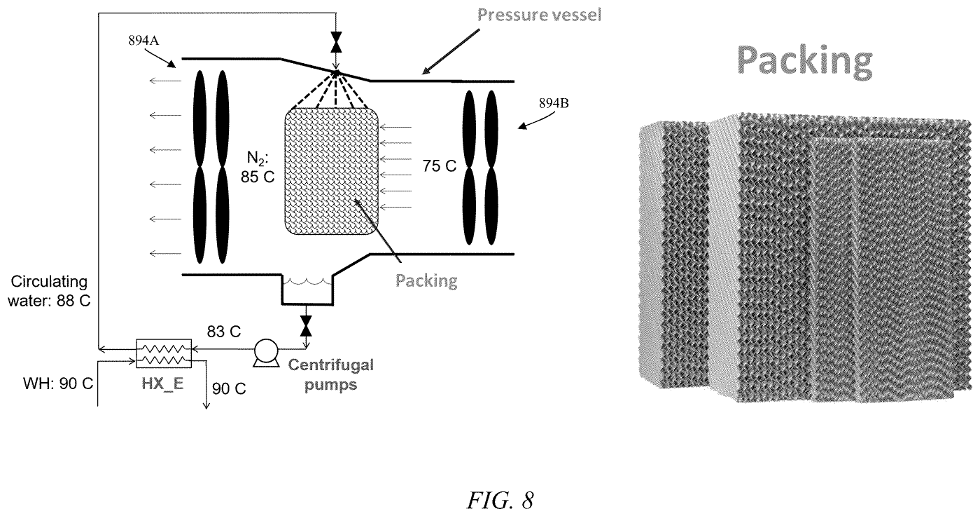

FIG. 8 shows a method for interheating, according to an embodiment of the disclosure. After each expansion, the gas cools, so it is reheated by directly contacting circulating hot water. To facilitate heat transfer, the hot water contacts the cool gas through wetted packing, such as Munters CELdek packing, structured packing typically employed in cooling towers (e.g., Brentwood Industries), or even dump packing. The circulating water is heated by contacting the source of waste heat. The indicated temperatures are typical for waste steam at 90° C. So the gas exiting the final expansion stage is at near-ambient temperature, the final expansion stages might not employ interheating.

When compressing the flue gas, a hybrid system can be employed that combines axial fans with conventional compressors. Initially, the volume is large, so axial compressors are most appropriate. Later, as the pressure increases and the volume decreases, conventional compressors can be employed. Similarly, when expanding the flue gas, the initial pressure is high and the volume is low; therefore, conventional expanders are appropriate. As the pressure reduces and the volume increases, axial turbines can be used.

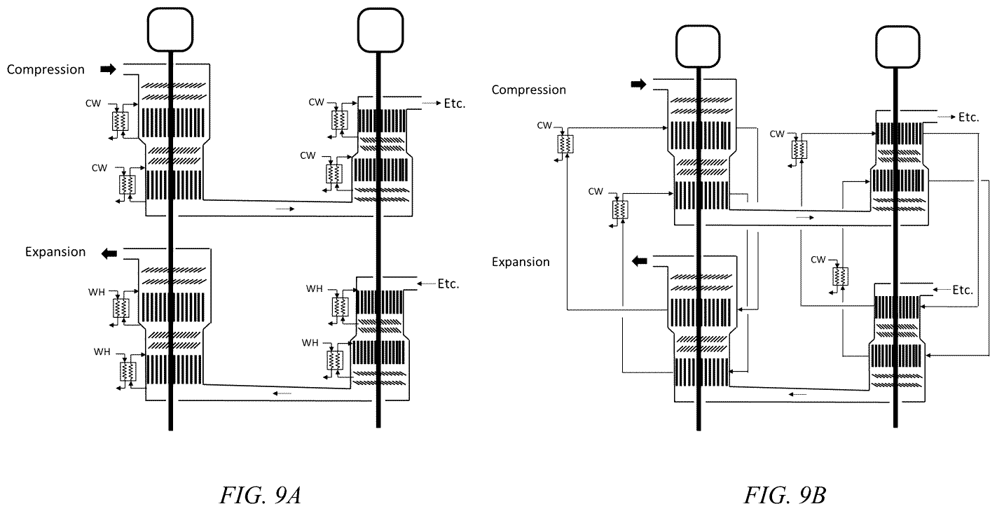

FIGS. 9A and 9B show the layout of the axial compressors and expanders, according to an embodiment of the disclosure. In the compression train, initially, the axial fans have a large diameter with a smaller rotation speed. Because the per-stage compression ratio is small, multiple fans can be placed in series. It is understood that each rotating fan includes stators that straighten the flow between the fans. As the compression occurs, temperature increases. Intercooling reduces the temperature, making compression more efficient. As shown in FIGS. 9A and 9B, two compression stages are employed before intercooling; however, this is just illustrative. More stages can be employed before intercooling.

In the expansion train, interwarming occurs between the expansion stages. As shown, two expansion stages are employed prior to interwarming; however more may be employed.

The expanders produce shaft power whereas the compressors consume shaft power. If the expander cannot supply enough shaft power for the compressors, an electric motor is employed to supply the remaining power. All the compressors and expanders that operate at a common speed are located on a single shaft. As the diameter of the compressors and expanders reduces, it may be necessary to design the system so that the shaft speed increases. If the interwarming temperature is high enough, the expanders will produce more power than is required by the compressors. In this case, a generator captures the excess shaft power and produces electricity.

FIG. 9A shows the configuration where each wetted pad has its own separate heat exchanger that supplies cooling to the compressor and heat to the expander. If no external source of heat is available, then the heat required for the expanders can be supplied from the compressors by simply circulating liquid water between pads of similar temperature and pressure. This approach reduces the cost of heat exchangers, which greatly reduces capital costs. Because more shaft power is required by the compressor than is delivered by the expander, the extra power input from the electric motor must be dissipated against cooling water or into the air via finned tube heat exchangers.

In Options A-1 (FIG. 4), A-2 (FIGS. 5) and A-3 (FIG. 6), the evolved carbon dioxide from each pressure letdown stage is compressed in a compressor train with intercooling. The compressor train could be a series of axial fans, such as those typically employed in the mining industry (FIG. 7), or they could be conventional compressors. The final discharge pressure is sufficiently high so that the carbon dioxide can be fed to a pipeline and ultimately disposed, either by utilization or sequestration. Typical sequestration pressures are about 150 bar.

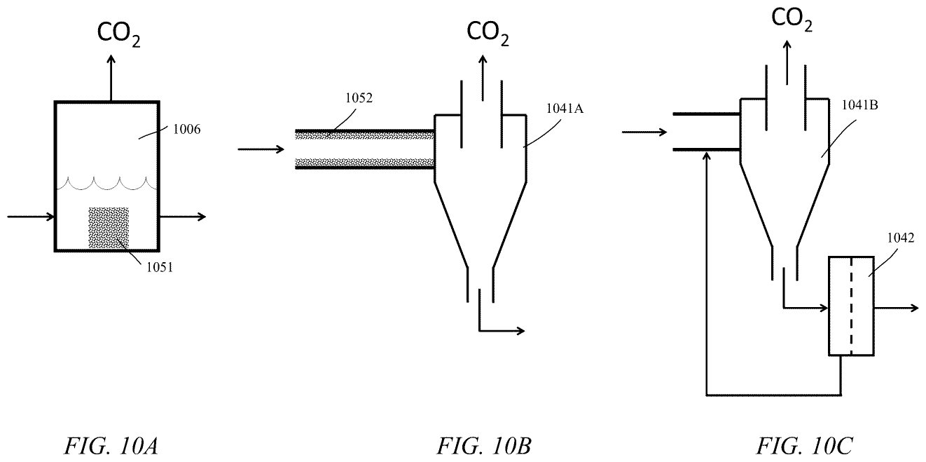

FIGS. 10A, 10B, and 10C illustrate three example methods for promoting nucleation of carbon dioxide gas bubbles when the pressure is reduced, according to an embodiment of the disclosure. FIG. 10A shows a tank 1006 that contains a porous high-surface material 1051 (e.g., sintered metal). The tank diameter is sufficiently large that the liquid disentrains from the gas. FIG. 10B shows a hydroclone 1041A that facilitates the separation of gas from liquid. In this approach, the wall 1052 of the pipe entering the hydroclone 1041A is covered with a porous high-surface material (e.g., sintered metal) that promotes nucleation. FIG. 10C shows a hydroclone 1041B that facilitates the separation of gas from liquid. In this approach, small particles of porous high-surface material (e.g., boiling chips) are suspended in the liquid. These particles are recovered by a suitable method (e.g., filtration 1042) and returned to the entrance to the hydroclone.

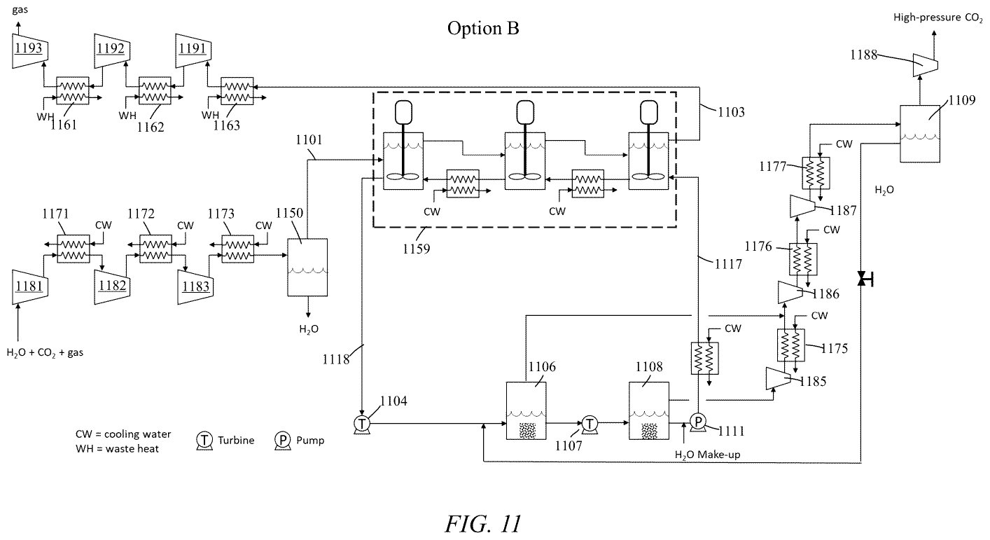

FIG. 11 shows Option B, according to an embodiment of the disclosure. Option B is identical to Option A, except that the absorption column is replaced with a series of stirred vessels 1159 through which the gas and liquid flow countercurrently. Stirring increases the rate that carbon dioxide dissolves into the liquid. Heat exchangers remove the thermal energy generated from stirring the liquid. It is possible to combine Options A and B; for example, most of the absorption could occur within a column and the final absorption stage could be a stirred vessel to ensure near-complete capture of carbon dioxide from the flue gas. While three vessels are generally shown, more or fewer than three vessels may be used in other configurations.

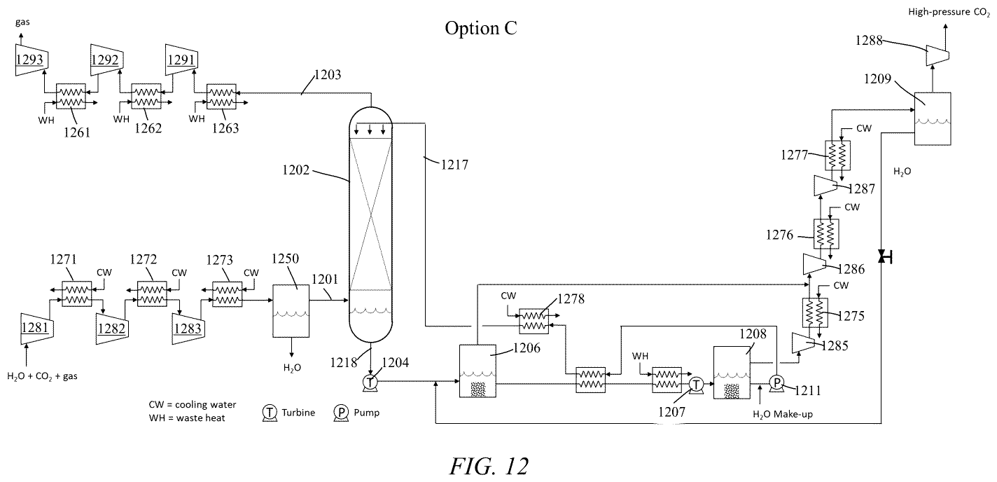

FIG. 12 shows Option C, according to an embodiment of the disclosure. Option C is identical to Option A-1, except that the liquid is heated to raise the temperature, which reduces Henry's constant (FIG. 1) and thereby lowers the concentration of carbon dioxide in the liquid returned to the absorption column. Furthermore, by raising the temperature, a greater fraction of the gas volume exiting 1218 the vessel 1202 is water vapor, which lowers the partial pressure of carbon dioxide and thereby further reduces the concentration of carbon dioxide in the liquid returned to the absorption column. In Option C, the carbon dioxide concentration entering the absorption column 1202 is reduced, which increases the recovery of carbon dioxide from the flue gas and/or reduces the required pressure in the absorption column.

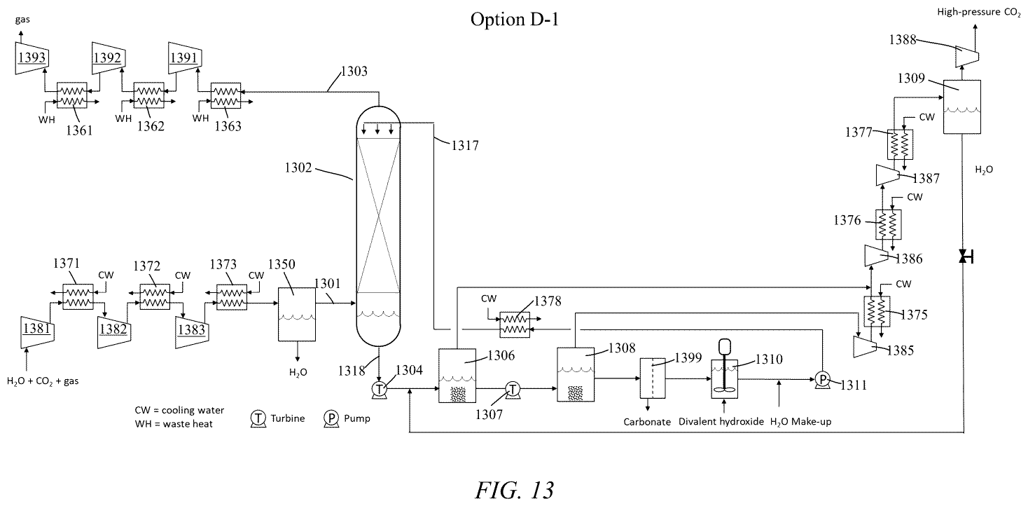

FIG. 13 shows Option D-1, according to an embodiment of the disclosure. Option D-1 which is identical to Option A, except that a divalent hydroxide is added to the circulating water. A mixing vessel 1310 is shown receiving the divalent hydroxide; however, other structures may be used.

Carbon dioxide is an “acid gas” that forms carbonic acid when dissolved in water.

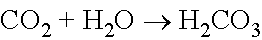

When adding a divalent hydroxide (e.g., calcium hydroxide), it reacts with carbonic acid to form carbonates.

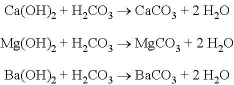

The carbonates have low solubility in water and can be recovered via filtration, settling, centrifugation, or other appropriate means (as generally represented by a filter 1399). The recovered carbonates can be thermally decomposed to create the corresponding oxide.

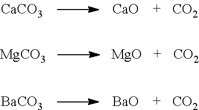

The resulting carbon dioxide is present at high concentrations and therefore is easily captured. The oxides can be added to water to make the hydroxides, which are then recycled.

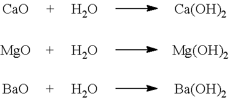

Table 1 summarizes key properties of each chemical.

TABLE 1
Solubility and decomposition temperature of divalent salts.
Solubility at room temperature (g/L)

| | |
|---|---|
| Ca(OH)₂ | 1.73 |
| Mg(OH)₂ | 0.0064 |
| Ba(OH)₂ | 52.3 |
| CaCO₃ | 0.013 |
| MgCO₃ | 0.139 |
| BaCO₃ | 0.024 |

Decomposition temperature at 1 atm (° C.)

| | |
|---|---|
| CaCO₃ | 700 to 900 |
| MgCO₃ | 350 |
| BaCO₃ | 1360 |

Of the candidate divalent alkalis presented, magnesium is advantageous because the decomposition temperature is low, which reduces energy costs.

Adding divalent alkalis allows for near-zero carbon dioxide concentration in the water entering the absorption column (FIG. 3B). In principle, with enough contact time in the absorption column, the partial pressure of carbon dioxide in the gas exiting the absorption column would approach zero. Adding excess alkali to the liquid in the absorption column allows for “residual alkalinity” in the water, which generates the partial pressure profile shown in FIG. 3C and allows the CO₂ concentration in the exiting flue gas to approach zero.

As shown in FIG. 13, the low-solubility carbonates are removed by suitable means, such as filtration, centrifugation, settling, etc. After the carbonates are removed, fresh divalent alkali is added. In FIG. 13, the removal of carbonates and addition of fresh divalent alkali occurs at near atmospheric pressure, which provides many options when selecting equipment.

Additional acid gases that are found in flue gas include SOₓ (e.g., SO₂, SO₃) and NOₓ (e.g., NO₂). These acid gases may be removed from the flue gas using conventional technologies; however, if these conventional technologies are not employed, these acid gases will react in the absorption column as follows:

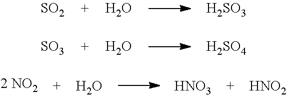

These acid gases react with divalent alkali as follows:

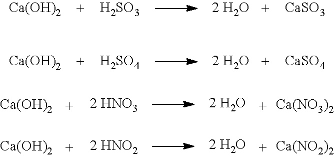

The calcium sulfate and sulfite are poorly soluble and will precipitate, and they will be mixed with the insoluble carbonates. These precipitated salts may be used to amend clay soils to improve fertility. In contrast, the calcium nitrate and nitrite are soluble and must be purged from the circulating water. These salts may be used as nitrogen fertilizer.

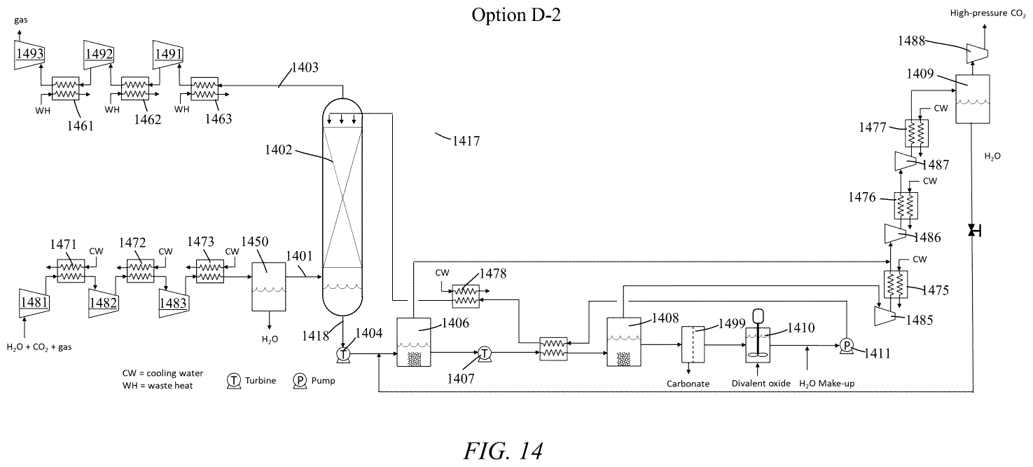

FIG. 14 shows Option D-2, according to an embodiment of the disclosure. Option D-2 is identical to Option D-1 except that the divalent oxide is added, which reacts with water in an exothermic reaction. The heat of reaction is captured to elevate the temperature of the final desorption stage, which enhances removal of carbon dioxide from water by lowering its solubility (FIG. 1).

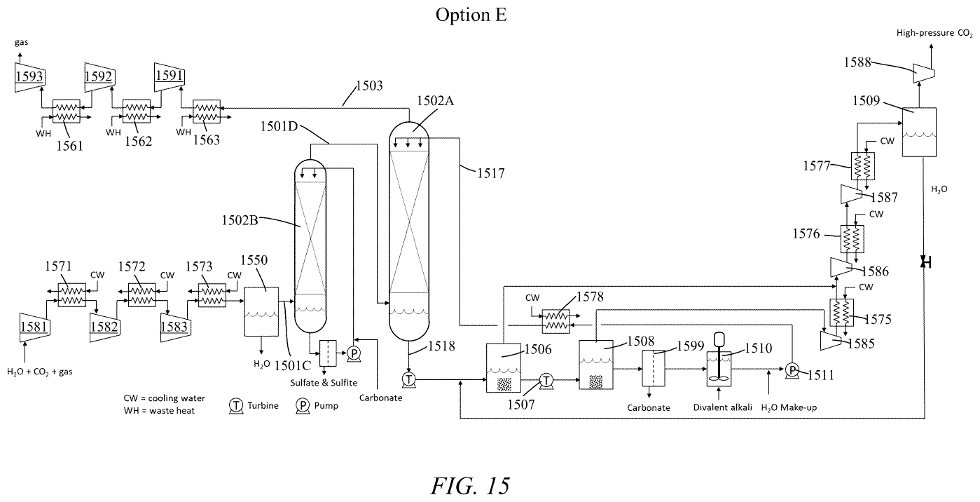

FIG. 15 shows Option E, according to an embodiment of the disclosure. Option E is like Option D-1, except that an additional absorption column 1502B has been added to capture SOₓ (e.g., SO₂, SO₃) from the flue gas. A suspended carbonate (e.g., calcium carbon, magnesium carbonate, dolomite) is added to the slurry in the absorption column 1502B. Using calcium carbonate as an example, the following reactions occur:

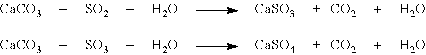

The resulting sulfites and sulfates are insoluble and are recovered by filtration, settling, centrifugation, or other appropriate methods. The sulfite and sulfate can be added to clay soils to improve fertility. The output 1501D of column 1502B enters column 1502a.

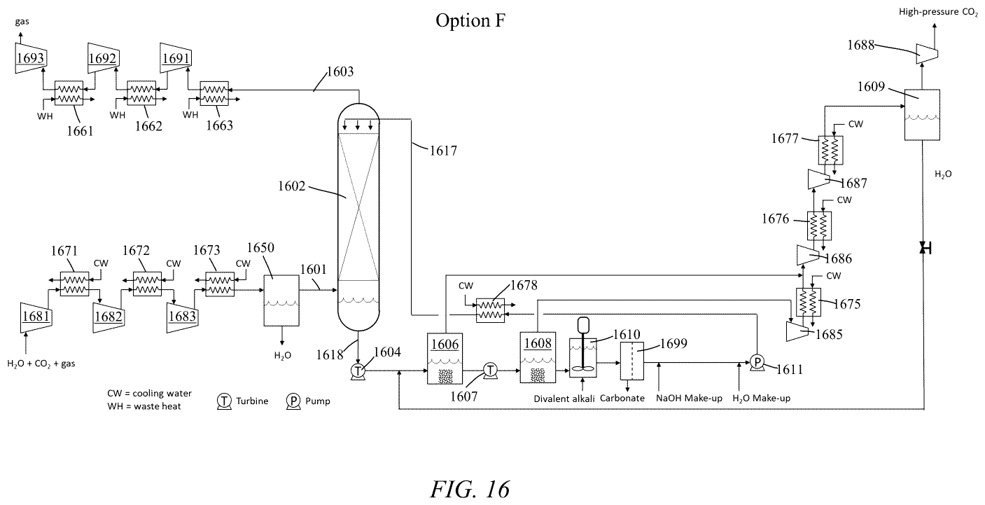

FIG. 16 shows Option F, according to an embodiment of the disclosure. Option F is essentially identical to Option D-1, except that a monovalent alkali (e.g., NaOH, KOH) is added to the water circulating through the absorption column. This circulating monovalent alkali provides “residual alkalinity” in the water, which ensures the partial pressure of carbon dioxide in the gas exiting the absorption column can approach zero (FIG. 3C) even with short contact times in the absorption column. The resulting monovalent carbonate is highly soluble in water, so it does not precipitate in the absorption column. However, when contacted with the divalent hydroxide (e.g., magnesium hydroxide), the carbonate precipitates.

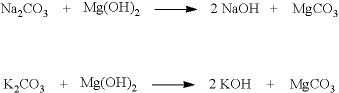

The precipitated carbonate is readily regenerated by thermal decomposition back to the corresponding oxide, as previously described.

Additional acid gases that are found in flue gas include SOₓ (e.g., SO₂, SO₃) and NOₓ (e.g., NO₂). These acid gases may be removed from the flue gas using conventional technologies; however, if these conventional technologies are not employed, these acid gases will react in the absorption column as follows:

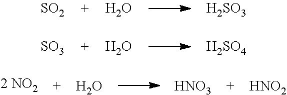

These acid gases react with the monovalent alkali as follows:

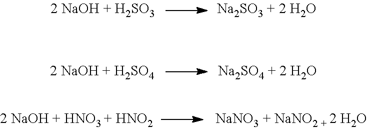

To recover the sodium ions, the salts can be reacted with calcium hydroxide, as follows:

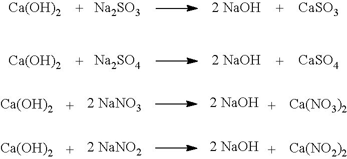

The calcium sulfate and sulfite are poorly soluble and will precipitate. These precipitated salts may be used to amend clay soils to improve fertility. In contrast, the calcium nitrate and nitrite are soluble and must be purged from the circulating water. These salts may be used as nitrogen fertilizer.

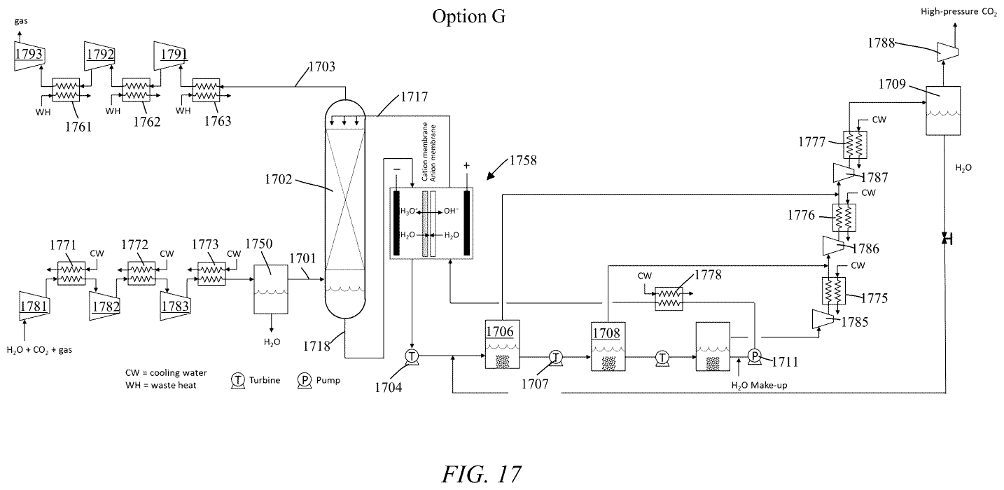

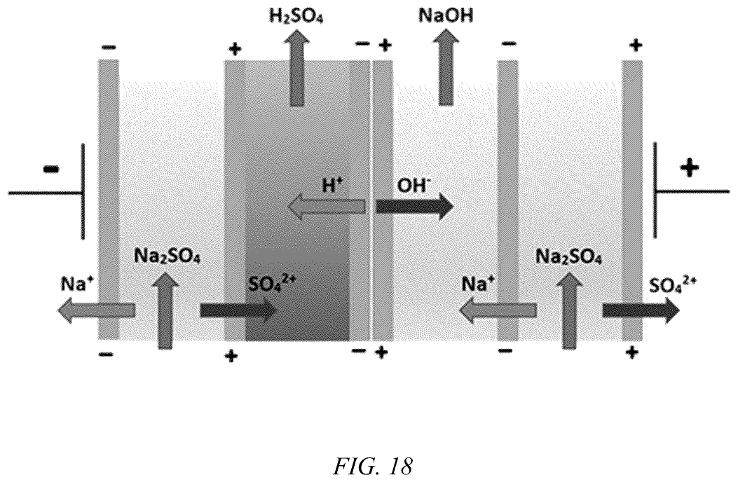

FIG. 17 shows Option G, according to an embodiment of the disclosure. Option G is like Option F, except that the alkali is regenerated electrochemically using water-splitting bipolar electrodialysis. In FIG. 17, the electrodialysis system 1758 is simplified; FIG. 18 shows the system 1758 in greater detail. In FIG. 18, the example salt is sodium sulfate (Na₂SO₄), although many other salts could be employed as well. The electrodialysis system consists of a series of alternating cation- and anion-selective membranes. When a voltage is applied by the electrodes, ions migrate as shown in FIG. 18, including the splitting of water. The total reaction is summarized below:

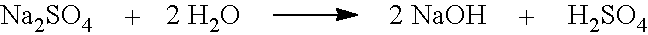

The NaOH and H₂SO₄ are produced in separate chambers. The NaOH is sent to the absorption column 1702 where the following reaction occurs:

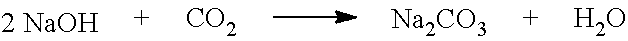

The sodium carbonate exiting 1718 the absorption column 1702 enters the acid chamber of the electrodialysis system 1758 where the following reaction occurs:

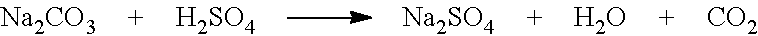

The carbon dioxide is released as a gas, which is captured and sequestered or utilized.

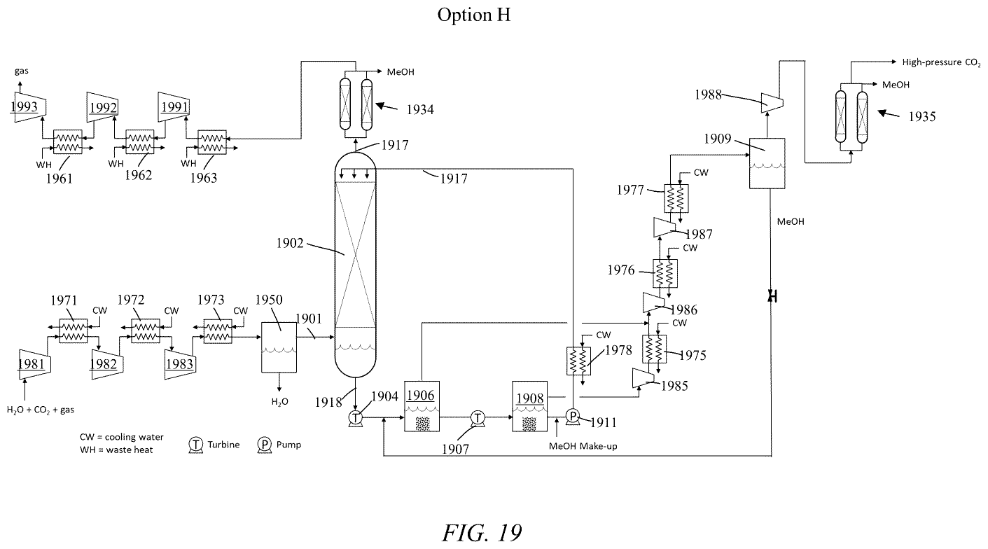

FIG. 19 shows Option H, according to an embodiment of the disclosure. Option H is like Option A, except that a solvent other than water is employed. FIG. 19 shows the solvent is methanol; however, other solvents may be employed such as ethanol, glycerol, 1,2 propanediol, poly (ethylene) glycol dimethyl ether (Selexol process), dimethyl carbonate, and propylene carbonate. Because many of these solvents are volatile, it is necessary to prevent them from escaping into the gas phase. To accomplish this, a solid adsorbent (e.g., activated carbon) is employed. Two beds 1934 are employed, one that is actively adsorbing and the other that is being regenerated. Typically, regeneration occurs by heating the bed (temperature swing) or applying a vacuum (pressure swing). Two beds 1935 are also shown just before the high-pressure CO₂ outlet.

If a solvent other than water is employed, it is not possible to deploy the alkaline chemistry described previously. In this scenario, a second absorption column would be employed that contains water with alkali.

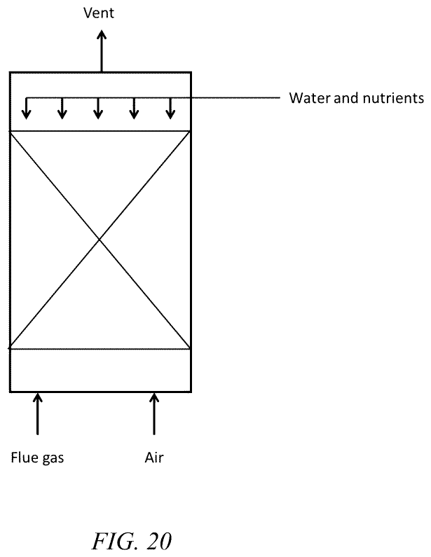

FIG. 20 shows a “biological filter,” according to an embodiment of the disclosure. The biological filter removes trace amounts of biodegradable contaminants from the vented flue gas. For example, if methanol were used as the physical solvent, trace amounts that escape from the adsorbent can be removed in the biological filter. Typically, a biological filter consists of a bed packed filled with wetted bark chips. The vented gas and air flow through the bark chips. Naturally occurring microorganisms establish themselves on the surface of the bark chips and metabolize trace chemicals in the effluent gas. To ensure that the microorganisms are healthy, small amounts of nutrients (e.g., urea, phosphate) can be added to the water.

### Integrated CO₂-Capture Processes

In the previously described add-on processes, compressors are required to pressurize flue gas, which elevates the partial pressure of CO₂ and thereby facilitates its dissolution into the physical solvent. In addition, expanders are required to recover energy from the remaining high-pressure gas. Unfortunately, the capital and energy costs of the compressors and expanders are substantial. These costs can be avoided by integrating CO₂ capture into power-production processes that combust fuels. For example, a gas turbine pressurizes air, combusts fuel, and expands the combustion gases to drive an electric generator. Typically, the combustion pressure is 20 to 60 bar; thus, the resulting CO₂ is already at high partial pressure. Of course, it is necessary to cool the combustion gas before the CO₂ can be recovered. Various processes that accomplish these steps are described as follows:

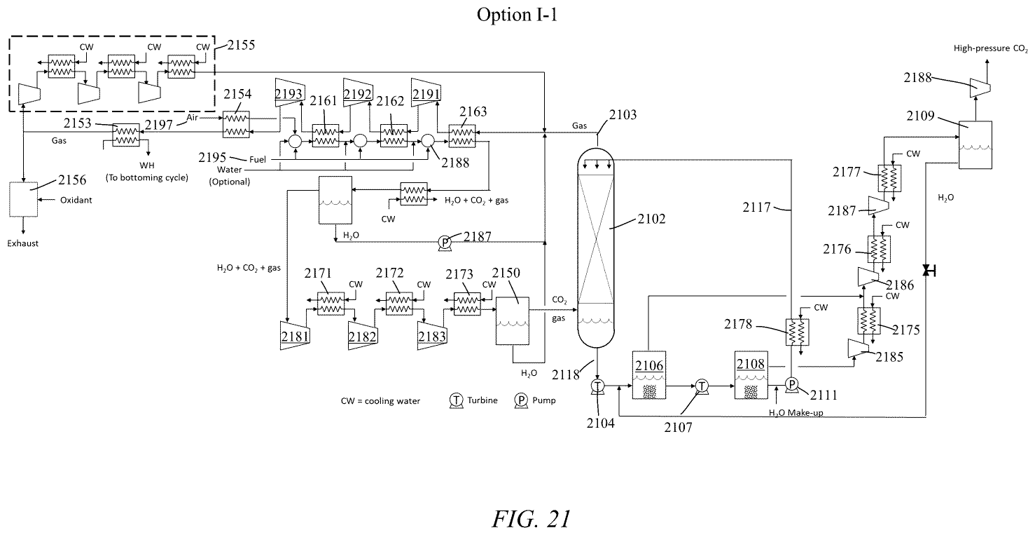

FIG. 21 shows Option I-1, according to an embodiment of the disclosure. Option I-1 is a power-production process that approximates the Ericsson cycle. Option I-1 is very similar to Option A-1. The primary difference is that Option A-1 uses low-temperature waste heat and Option I-1 combusts fuel (shown generally as 2195) to purposely create high-temperature heat. In Option I-1, the added air (shown generally as 2197) flows in series through the combustors (one of the combustors labeled 2188). Some or all the combustors have excess air, which promotes complete combustion.

Optionally, small amounts of water can be added to the combustors 2188, which cools the flame temperature and reduces NOₓ formation. The water can be added either as a liquid or vapor (steam). Optionally, larger amounts of water can be added to the combustor 2188 such that stoichiometric, or sub-stoichiometric, amounts of fuel can be combusted without causing excessively high combustion temperatures.

In Option I-1, combustion occurs at near-ambient pressure. The hot combustion gas exchanges heat with high-pressure gas that flows through the expanders (2191, 2192, 2193). In the final heat exchanger, the combustion gas is cooled sufficiently so that water in the combustion gas condenses as liquid, and it is thereby removed. Ideally, this condensed water is recycled to the outlet of the heat exchanger, as explained below.

Water recycle is important because it allows the enthalpy-temperature profiles on each side of the heat exchanger to nearly match, which reduces irreversibilities and thereby improves system efficiency. As shown in FIG. 21, the recycled water is supplied directly from the water condensed from the combustion gas; however, it could come from any source. If sourced from the condenser, this water will be saturated with carbon dioxide. To reduce carbon dioxide emissions from this source, the pressure of this CO₂-saturated water could be dropped, which allows CO₂ to bubble out and be recovered. After the CO₂ is recovered, the water would be pressurized by a pump 2187 and returned to the heat exchanger.

The cooled semi-dry gas is compressed using a series of compressors (2181, 2182, 2183) with intercoolers (2171, 2172, 2173) that maintain near-ambient temperatures in the compression. Because of the elevated pressure and cool temperature, most of the remaining water in the gas will condense. The remaining gases enter the absorption column 2102 where CO₂ is removed. The gas exiting 2103 the absorption column 2102 is substantially free of CO₂ and contains primarily nitrogen, argon, and possibly oxygen if excess oxygen is employed in the combustors. Because most of the water and CO₂ have been removed, the mass of this gas mixture is less than that of the combustion gas. To ensure there is enough thermal mass in the heat exchangers, liquid water and additional high-pressure gas are added to the stream. This additional high-pressure gas could be air; however, as shown in FIG. 21, it is recirculated combustion gas, which reduces the oxygen concentration in the heat exchangers.

The gas exiting the final expansion stage is at near-ambient pressure. It is still hot, so incoming combustion air is preheated (see heat exchanger 2154) to recover thermal energy. The thermal mass of the incoming air is insufficient to capture all the thermal energy in the outgoing gas, so an additional heat exchanger 2153 can be employed. To optimize energy efficiency, the captured waste heat can be used in a “bottoming cycle” that makes additional power.

As shown, FIG. 21 includes a recuperator 2154; however, it could be removed, which allows more energy to enter the bottoming cycle and thereby make more shaft power.

As shown in FIG. 21, some of the effluent gas is compressed and recycled (e.g., box labeled 2155 with compressors and intercoolers), as described previously. The remaining gas is vented to the atmosphere. If the gas contains unreacted fuel or other gases such as carbon monoxide, optionally it may be sent to a reactor 2156 that completes the oxidation process before the gases are vented to the atmosphere. The reactor could be a biological filter (FIG. 19) in which the oxidant is air. However, other reactors could be employed such as those that use catalysts to facilitate the reaction. In addition to air or oxygen, other oxidants (e.g., ozone, hydrogen peroxide) could be deployed.

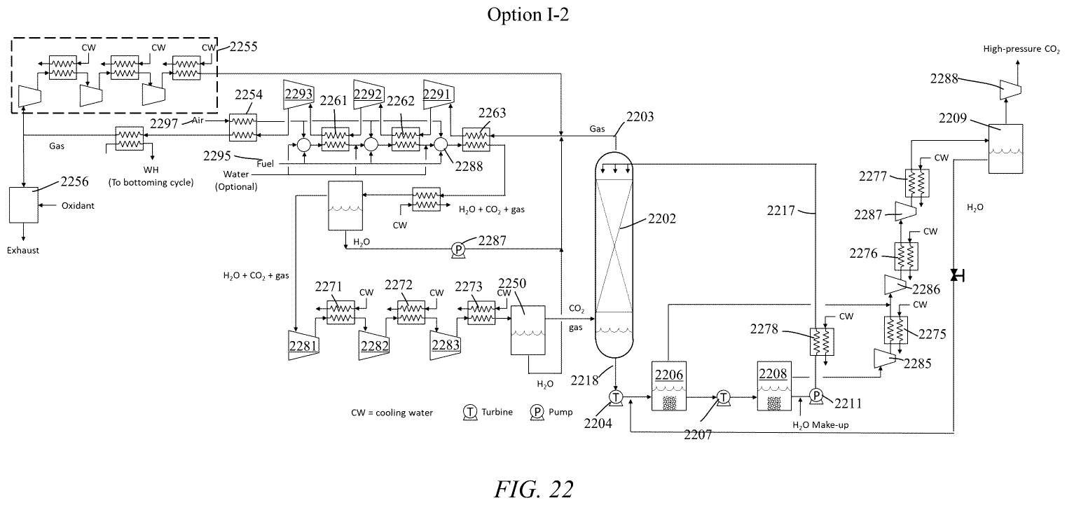

FIG. 22 shows Option I-2, according to an embodiment of the disclosure. Option I-2 is similar to Option I-1 except that the added air flows in parallel through the combustors 2288. If fuel is added in slight excess to each combustor 2288, reducing conditions are maintained in all heat exchangers, which increases the maximum operating temperature of many metals that are used in high-temperature heat exchangers.

In the multi-step combustion processes shown in Options I-1 and I-2, a key issue is to determine the number of combustion steps required to achieve stoichiometric combustion of fuel, which will maximize the concentration of carbon dioxide in the gas entering the absorber. The standard-state heat of combustion for each fuel is listed below. The inlet air is assumed to contain 21 mol % oxygen.

$$\begin{matrix}Methane & {CH}_{4} + 2 {O}_{2} + 2 \frac{100 - 21}{21} {N}_{2} \to C {O}_{2} + 2 {H}_{2} O + 2 \frac{100 - 21}{21} {N}_{2} \\ & {CH}_{4} + 2 {O}_{2} + 7.523 {N}_{2} \to C {O}_{2} + 2 {H}_{2} O + 7.523 {N}_{2} \\ & Δ {H}_{lower} = \frac{802.5 kJ}{mol {CH}_{4}} = \frac{8 2.5 kJ}{1 mol {CO}_{2} + 7.523 mol {N}_{2}} = \frac{94.15 kJ}{mol of 88.3 \% {N}_{2}} \\ Coal & {CH}_{0.9} {O}_{0.1} + 1.1 \; 75 {O}_{2} + 1.175 \frac{100 - 21}{21} {N}_{2} \to C {O}_{2} + 0.45 {H}_{2} O + 1.175 \frac{100 - 21}{21} {N}_{2} \\ & {CH}_{0.9} {O}_{01} + 1.1 \; 75 {O}_{2} + 4.42 {N}_{2} \to C {O}_{2} + 0.45 {H}_{2} O + 4.42 {N}_{2} \\ & Δ {H}_{higher} = \frac{32.9 \; 62 kJ}{g raw coal} \times \frac{g raw coal}{0.938 g {CH}_{0.9} {O}_{0.1}} \times \frac{14.5 g {CH}_{0.9} {O}_{0.1}}{mol {CH}_{0.9} {O}_{0.1}} = \frac{509.5 kJ}{mol {CH}_{0.9} {O}_{0.1}} \\ & Δ {H}_{lower} = \frac{509.5 kJ}{mol {CH}_{0.9} {O}_{0.1}} - \frac{0.45 mol {H}_{2} O}{mol {CH}_{0.9} {O}_{0.1}} \times \frac{44.02 kJ}{mol {H}_{2} O} = \frac{489.7 kJ}{mol {CH}_{0.9} {O}_{0.1}} \\ & Δ {H}_{lower} = \frac{489.7 kJ}{mol {CH}_{0.9} {O}_{0.1}} = \frac{489.7 kJ}{1 mol {CO}_{2} + 4.42 mol {N}_{2}} = \frac{9 0.36 kJ}{mol of 81.5 \% {N}_{2}} \\ Biomass & {CH}_{1.5} , {O}_{0.6} + 1.0 \; 75 {O}_{2} + 1.075 \frac{100 - x}{x} {N}_{2} \to C {O}_{2} + 0.75 {H}_{2} O + 1.075 \frac{100 - x}{x} {N}_{2} \\ & {CH}_{1.5} , {O}_{0.6} + 1.0 \; 75 {O}_{2} + 4.044 {N}_{2} \to C {O}_{2} + 0.75 {H}_{2} O + 4.0 \; 44 {N}_{2} \\ & Δ {H}_{higher} = \frac{2 0.75 kJ}{g raw biomass} \times \frac{g raw biomass}{0.9 \; 94 g {CH}_{1.5} , {O}_{0.6}} \times \frac{23. 1 g {CH}_{1.5} , {O}_{0.6}}{mol {CH}_{1.5} , {O}_{0.6}} = \frac{4 82.2 kJ}{mol {CH}_{1.5} , {O}_{0.6}} \\ & Δ {H}_{lower} = \frac{482.2 kJ}{mol {CH}_{1.5} , {O}_{0.6}} - \frac{0.75 mol {H}_{2} O}{mol {CH}_{1.5} , {O}_{0.6}} \times \frac{4 4.02 kJ}{mol {H}_{2} O} = \frac{449.2 kJ}{mol {CH}_{1.5} , {O}_{0.6}} \\ & Δ {H}_{lower} = \frac{449.2 kJ}{mol {CH}_{0.9} {O}_{0.1}} = \frac{449.2 kJ}{1 mol {CO}_{2} + 4.0 \; 44 mol {N}_{2}} = \frac{89.06 kJ}{mol of 80.2 \% {N}_{2}}\end{matrix}$$

In the analysis, the following assumptions are employed:
Per-stage pressure ratio=2 (typical of radial turbomachines)
Combustor=1200° C.
Expander inlet temperature=1100° C.
N₂ composition=81 mol %
CO₂ composition=19 mol %
Isentropic expansion

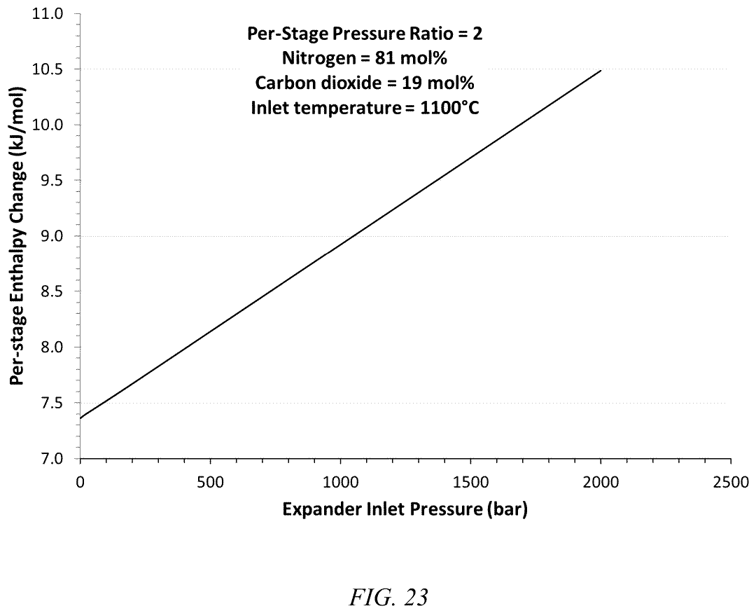

Using these assumptions, FIG. 23 shows the per-stage enthalpy change, which is the isentropic (theoretical) work that can be produced by each expansion stage. Most of the expansions will occur at low pressure, so a weighted-average per-stage enthalpy change is about 8 KJ/mol. If the expansions are isentropic, approximately 11 expansion stages are required. Assuming the expanders are 85% efficient, approximately 13 to 14 expansion stages are required to achieve stoichiometric combustion. With a per-stage pressure ratio of 2 and a final expansion pressure of 1 bar, the inlet pressure to the expander train must be 2¹⁴=16,384 bar. Clearly, this is not practical. Consequently, the combustors in Options I-1 and I-2 must operate sub-stoichiometric, which is why gases (primarily nitrogen) are recycled. Because of gas recycle, the CO₂ concentration will be significantly less than stochiometric, which increases the cost of capturing the carbon dioxide.

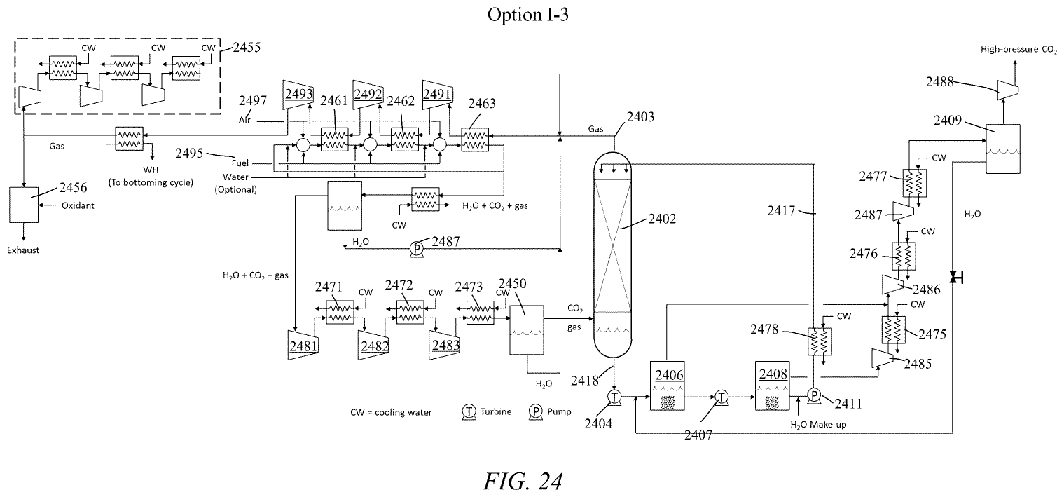

FIG. 24 shows Option I-3, according to an embodiment of the disclosure. Option I-3 employs a recycle loop to the beginning of the combustor train. The recycle rate is specified so that the carbon dioxide concentration is approximately the stoichiometric concentration. A purge stream is tapped from the recycle loop, which is sent to the system that captures carbon dioxide. In this embodiment, the recuperator has been removed so that the incoming air is as cool as possible. This allows more fuel to be combusted and achieve near-stoichiometric carbon dioxide concentrations. When the recuperator is removed, more thermal energy is available to the bottoming cycle.

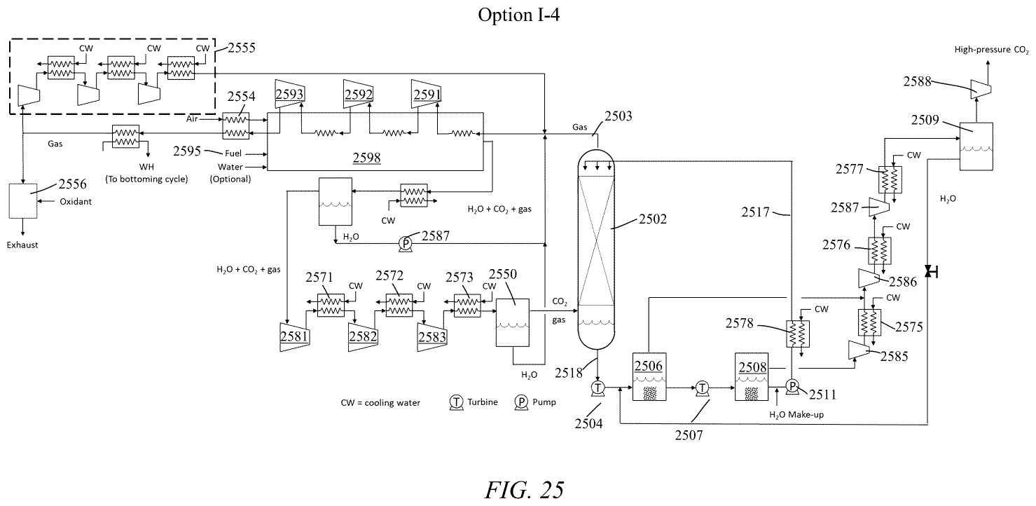

FIG. 25 shows Option I-4, according to an embodiment of the disclosure. Option I-4 employs a single combustor 2598 with multiple heat exchangers removing heat from the combustor. The single well-mixed combustor is equivalent to the multi-stage combustor with recycle (Option I-3). The combustor can operate near-stoichiometrically, which increases the carbon dioxide concentration and thereby reduces the separation cost. As shown, the recuperator is included to preheat the combustion air; however, it could be removed and thereby allow more power to be produced in the bottoming cycle.

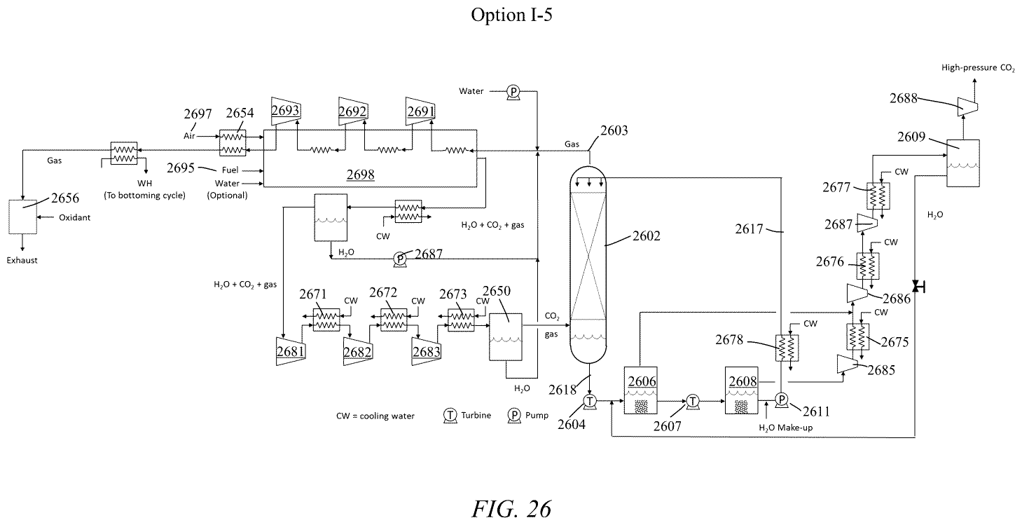

FIG. 26 shows Option I-5, according to an embodiment of the disclosure. Option I-5 replaces the compression train that provides make-up gas with liquid water. The liquid water mixes with the gas that has been stripped of CO₂ and makes steam in the heat exchanger. This approach eliminates the capital cost of the compressor train and replaces it with an inexpensive pump. Because of the inherent irreversibility associated with vaporizing a liquid (latent heat) with a hot gas (sensible heat), less power is made with this approach; however, the lower capital cost may make it attractive in some situations. Of course, this option of replacing the compressor train with a liquid water pump can be practiced with any of the embodiments shown herein. Here, it is applied to Option I-4 as an illustrative example.

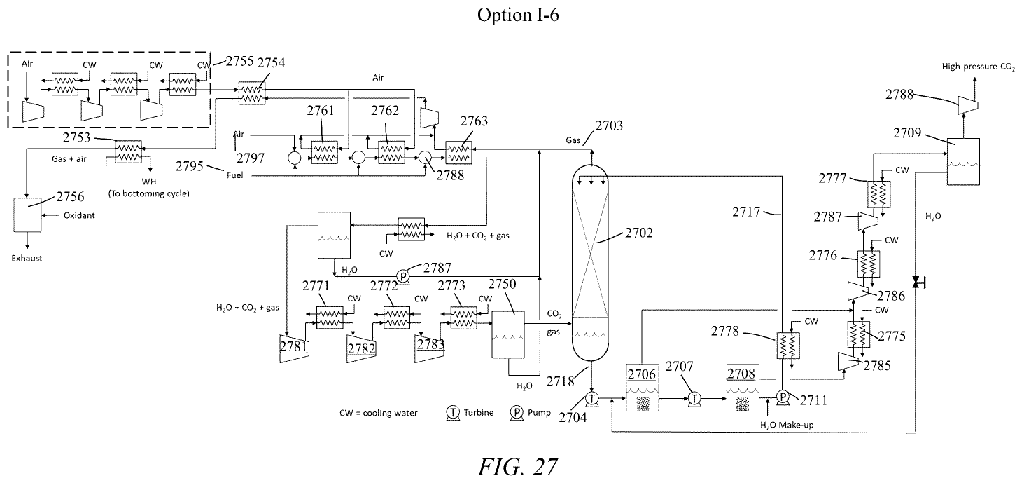

FIG. 27 shows Option I-6, according to an embodiment of the disclosure. Option I-6 employs series of ambient-pressure combustors with parallel heat extraction. Air and fuel are added to a series of combustors 2788 in a stepwise manner. As shown, all the air is added to the leftmost combustor and fuel is metered into each sequential combustor 2788 such that the temperature never exceeds material limits. Alternatively, all the fuel could be added to the leftmost combustor and air is metered into each sequential combustor. Alternatively, both could be metered into each combustor.

An air compressor 2755 pressurizes air that is fed to heat exchangers 2761 and 2762 that heat the compressed air prior to expansion. Because the air contains little moisture and the hot combustion gases never cool enough to condense water, only sensible heat must be transferred between combustion gases and air.

After the combustion is completed to near-stoichiometric conditions, the gas is cooled so that carbon dioxide can be recovered. In this case the temperature of the combustion gas is reduced sufficiently so that water does condense; thus, the heat exchanger exchanges both sensible and latent heat. To match the enthalpy-temperature profile in the heat exchanger, liquid water must be recycled to the heat exchanger.

As shown, air compression 2755 is accomplished with interstage cooling, which allows for highly efficient near-isothermal compression. To preheat the air, a recuperator 2754 is employed. Alternatively, rather than isothermal compression, air could be compressed adiabatically, which would either eliminate the need for the recuperator, or make it smaller.

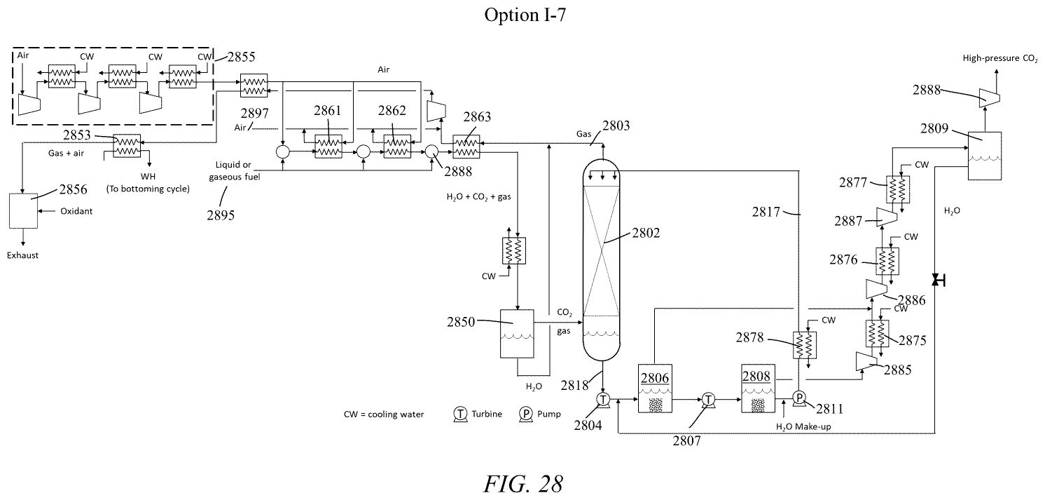

FIG. 28 shows Option I-7, according to an embodiment of the disclosure. Option I-7 is like Option I-6, except the combustors operate at high pressure.

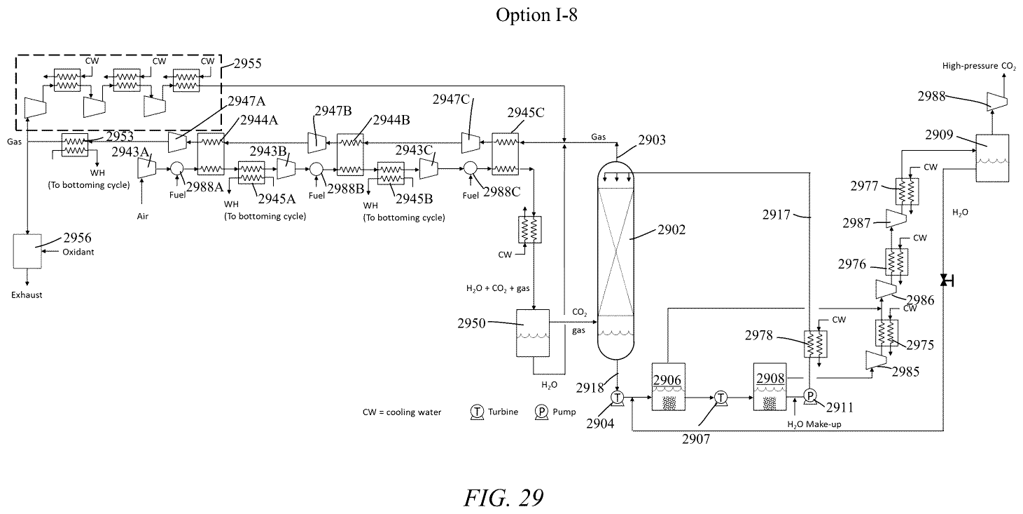

FIG. 29 shows Option I-8, according to an embodiment of the disclosure. Option I-8 employs multi-stage combustion to achieve near-stoichiometric CO₂ concentrations in the flue gas. Air is compressed (compressor 2943A) and sent to a combustor 2988A where a portion of the stoichiometric fuel is added. A countercurrent heat exchanger 2944A removes a portion of the thermal energy and transfers it to the stream from which CO₂ was removed. Additional thermal energy is removed in heat exchanger 2945A from the combustion gas exiting heat exchanger 2944A and is used to create work in a bottoming cycle. Cooled combustion gas from heat exchanger 2945A is compressed further to a higher pressure in compressor 2943B and combusted with additional fuel in combustor 2988B. Heat is transferred in heat exchanger 2944B from the combustion gas exiting combustor 2988B to the stream from which CO₂ was removed. Additional thermal energy is again removed from the combustion gas (heat exchanger 2945B) and is used to create work in a bottoming cycle. This process is repeated in compressor 2943C, combustor 2988C, and heat exchanger 2945C, whereby the combustion gas is substantially free of oxygen and the combined air-to-fuel ratio is near-stoichiometric. After all the useful thermal energy has been extracted from the flue gas, it is cooled to near-ambient temperature, allowing CO2 to be removed, as in other embodiments. Flue gas from which the CO₂ has been removed is reheated in heat exchanger 2945C, expanded in expander 2947C, reheated in heat exchanger 2945B, expanded in expander 2947B, reheated in heat exchanger 2945A, expanded in expander 2947A, reheated against compressed gas from compressor 2943A, and further cooled in heat exchanger 2953 against a fluid used in a bottoming cycle.

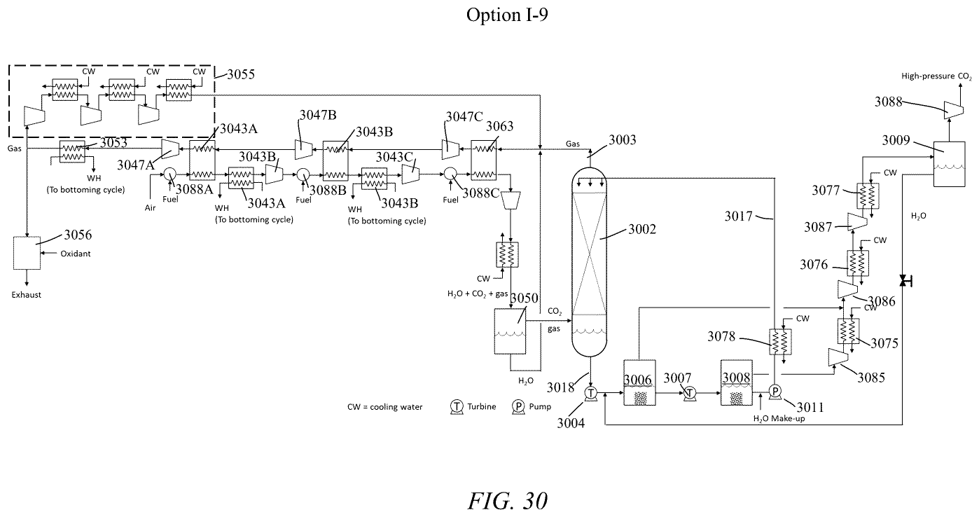

FIG. 30 shows Option I-9, according to an embodiment of the disclosure. Option I-9 is like Option I-8, except the first combustor 3088A operates at ambient pressure, which makes it convenient for using solid fuels. The remaining combustors (e.g., 3088B, 3088C) operate at elevated pressure where liquid and gaseous fuels are more convenient.

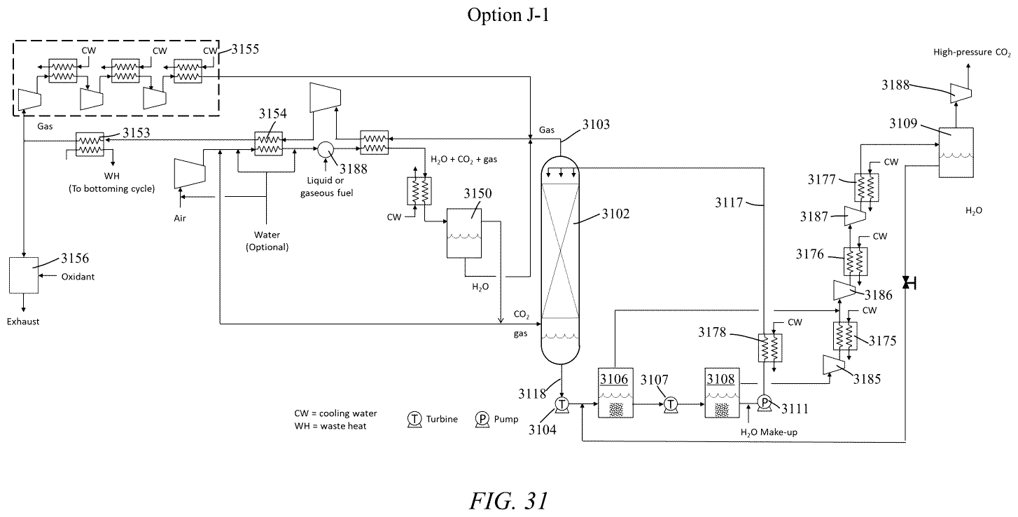

FIG. 31 shows Option J-1, according to an embodiment of the disclosure. Option J-1 integrates carbon dioxide capture with a recuperated Brayton cycle. The combustor operates at elevated pressure, so it is most convenient to employ liquid or gaseous fuels, which are easily pressurized. To achieve near-stoichiometric carbon dioxide concentrations, gas is recycled. Because the recycled gas is cold but the compressor discharge is hot, there is some loss in efficiency. This could be eliminated by multi-stage compression with intercooling, as was employed in Options I. As described previously, an alternative method for achieving near-stoichiometric carbon dioxide concentrations is to inject water (liquid or steam) into the combustor, which lowers the combustion temperature and thereby allows more fuel to be combusted with oxygen. Additionally, atomized liquid water can be added to the compressor inlet, which helps achieve near-isothermal compression. Yet another option is to add liquid water (preferably atomized) to the compressor outlet, which lowers the temperature and thereby allows more heat to be captured by the recuperator. If sufficient water is added, there is no need to recycle gas. Of course, to achieve near-stoichiometric carbon dioxide concentrations, a hybrid system can be employed with both gas recycle and water addition. As shown, FIG. 31 includes a recuperator 3154; however, this could be removed, which increases the amount of energy available to the bottoming cycle 3153.

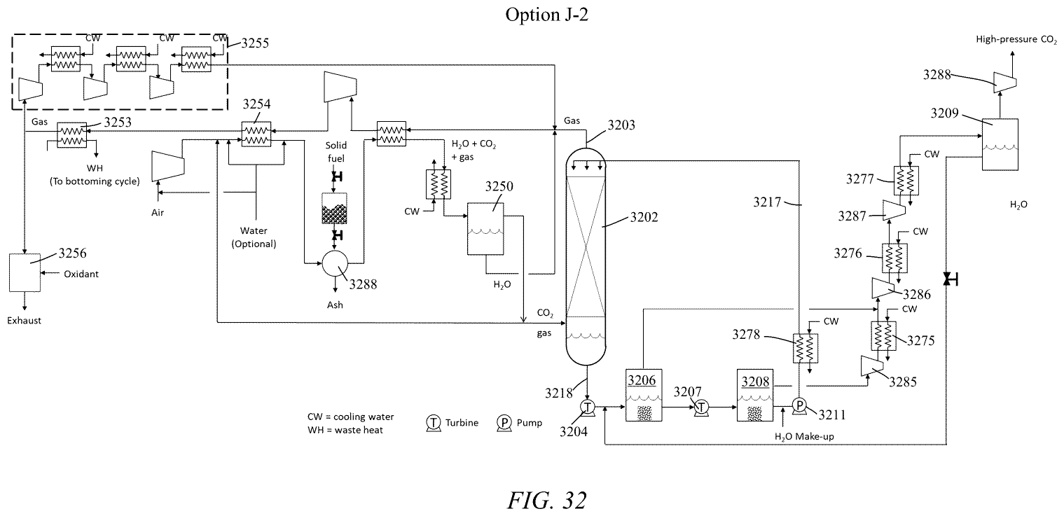

FIG. 32 shows Option J-2, according to an embodiment of the disclosure. Option J-2 is similar to Option J-1; however, in this case, solid fuel (e.g., coal, biomass) is introduced through a lock hopper.

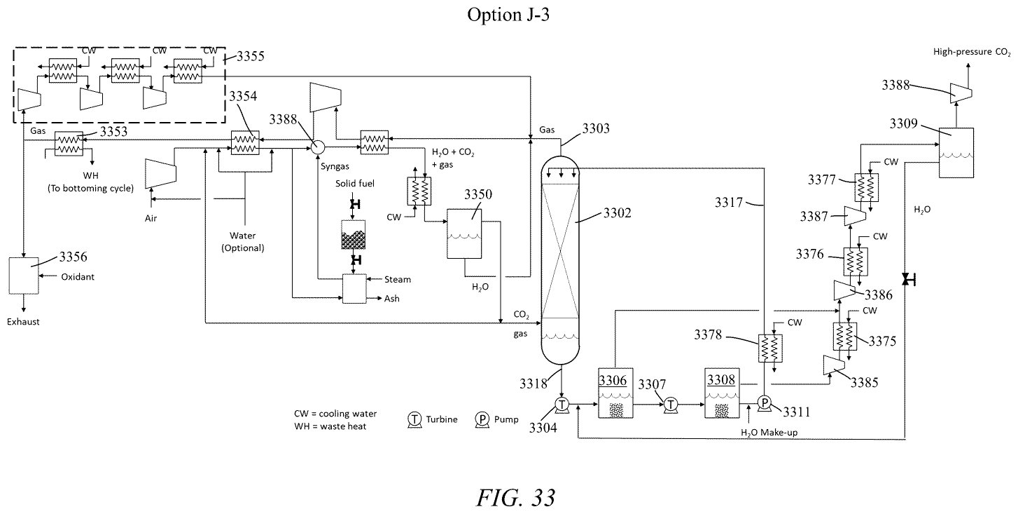

FIG. 33 shows Option J-3, according to an embodiment of the disclosure. Option J-3 is like Option J-2; however, in this case, solid fuel (e.g., coal, biomass) is introduced through a lock hopper into a high-pressure gasifier. The gases and liquids from the gasifier flow into the combustor, which operates at elevated temperatures. One advantage of using a gasifier is that it operates at a lower temperature than a combustor, so the ash may not melt and cause problematic slag.

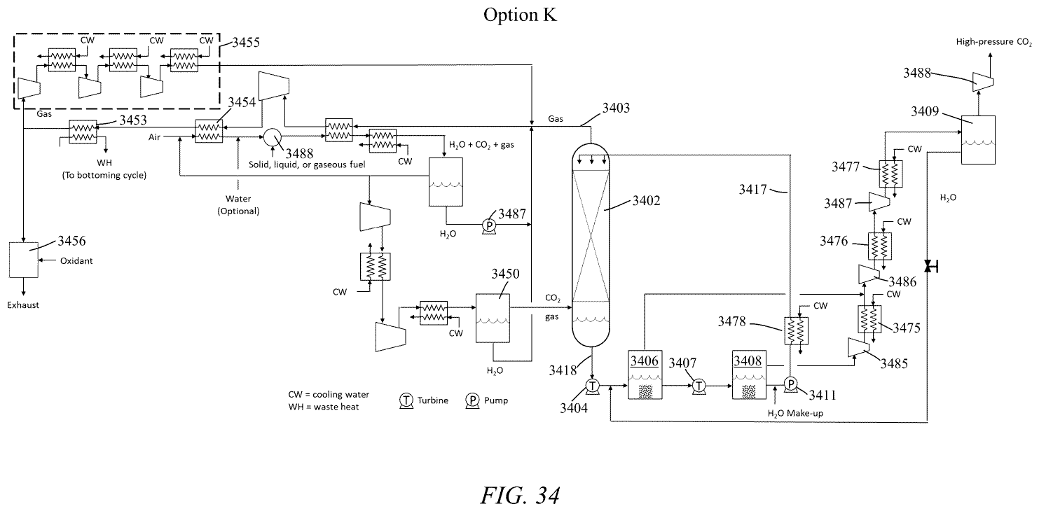

FIG. 34 shows Option K, according to an embodiment of the disclosure. Option K which is similar to Option J-1, except that a single expander is employed; thus, it is not possible to reheat between the expansion stages. As shown, FIG. 34 includes a recuperator 3454; however, this could be removed, which increases the amount of energy available to the bottoming cycle.

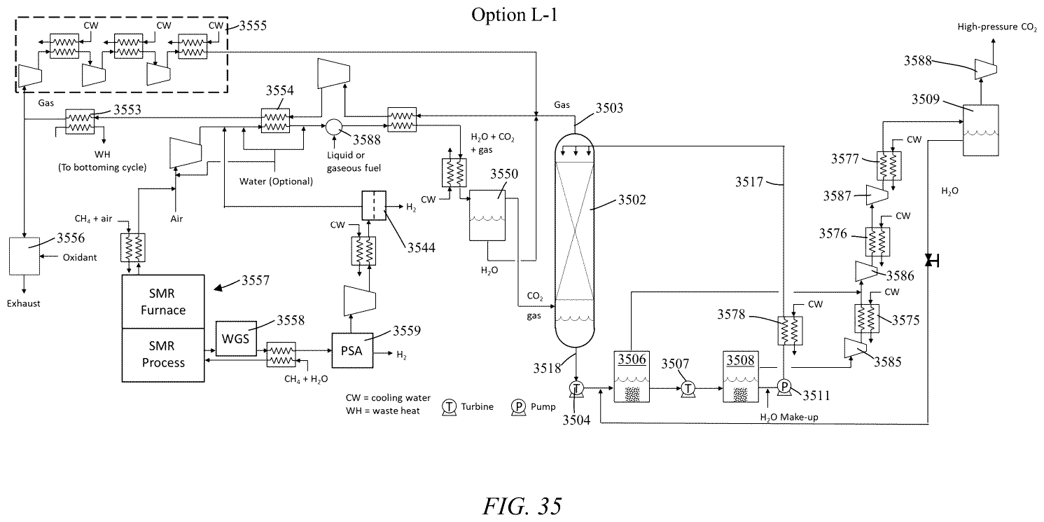

FIG. 35 shows Option L-1, according to an embodiment of the disclosure. Option L-1 integrates a steam methane reformer (SMR) 3557 with power production. In this example, the SMR 3557 is integrated with power production Option J-1; however, the SMR 3557 can be integrated with any of the other power production cycles. Reforming methane with steam is an endothermic reaction, so the reactor must be integrated with a combustor that provides the necessary heat. The gas produced by the SMR 3557 contains carbon monoxide, which is often not a desired product.

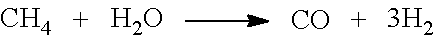

Using the water gas shift (WGS) 3558, carbon monoxide is converted to carbon dioxide.

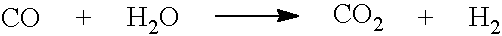

The net reaction is:

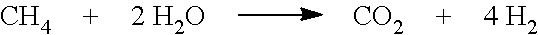

Because the reactions may not be complete, the final product contains not only CO₂, but also CO and CH₄. By integrating the process with power production, the energy content in these unreacted gases is recovered in a productive manner. Furthermore, the CO₂ is readily recovered in the same equipment that recovers CO₂ from the power production process. The fuel consumption by the SMR is envisioned to be small relative to the fuel consumption in the power production process; therefore, the added cost for capturing carbon dioxide is marginal and takes advantage of economies of scale. Hydrogen is separated from other gases using pressure swing adsorption (PSA) 3559, membranes 3544, or other suitable means.

As shown, FIG. 35 includes a recuperator 3554; however, this could be removed, which increases the amount of energy available to the bottoming cycle 3553.

In Option L-1, the combustor operates at elevated pressure, making it most suitable for combusting gaseous or liquid fuels.

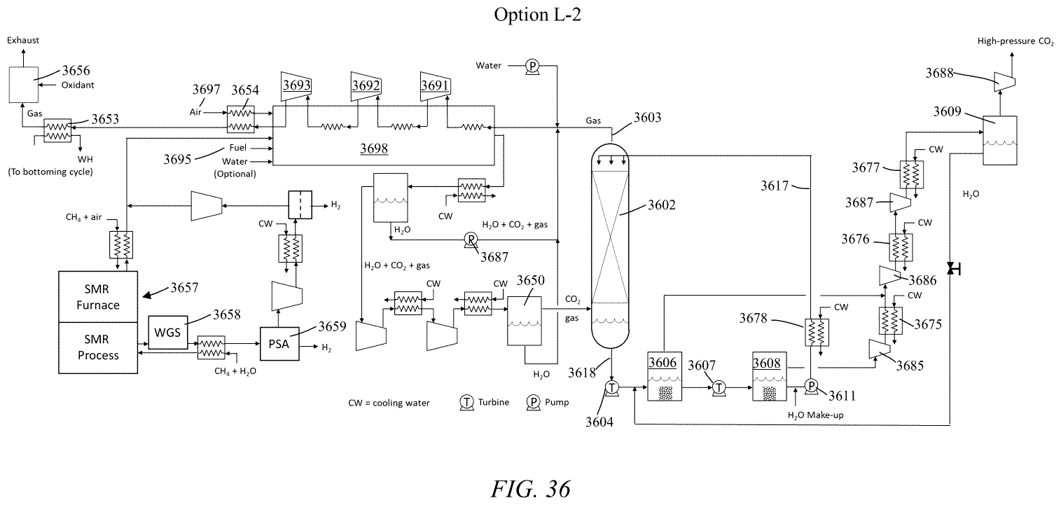

FIG. 36 shows Option L-2, according to an embodiment of the disclosure. Option L-2 integrates a steam methane reformer (SMR) 3657 with power production. In this example, the SMR 3657 is integrated with power production Option I-4; however, the SMR 3657 can be integrated with any of the other power production cycles. In this example, the objective is to integrate with a combustor that operates at near-ambient pressure, which is convenient for solid fuels. In particular, if biomass is used as the feedstock, then the entire process is carbon negative.

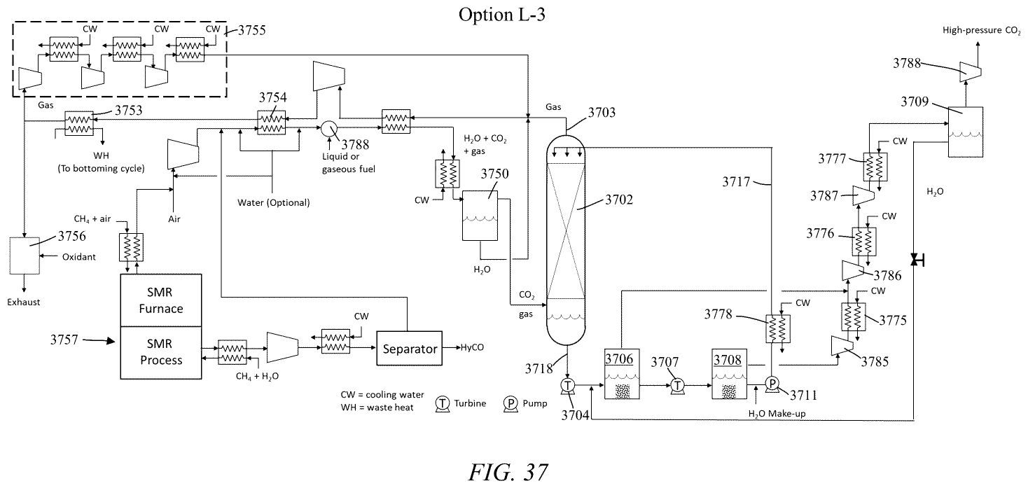

FIG. 37 shows Option L-3, according to an embodiment of the disclosure. Option L-3 is like Option L-1, except that the product gas is HyCO (primarily a mixture of hydrogen and carbon monoxide) rather than hydrogen alone. Because it can be used to synthesize many chemicals and fuels, HyCO is also called synthesis gas (syngas).

To recover HyCO, there are numerous separation options (e.g., pressure swing absorption, membranes).

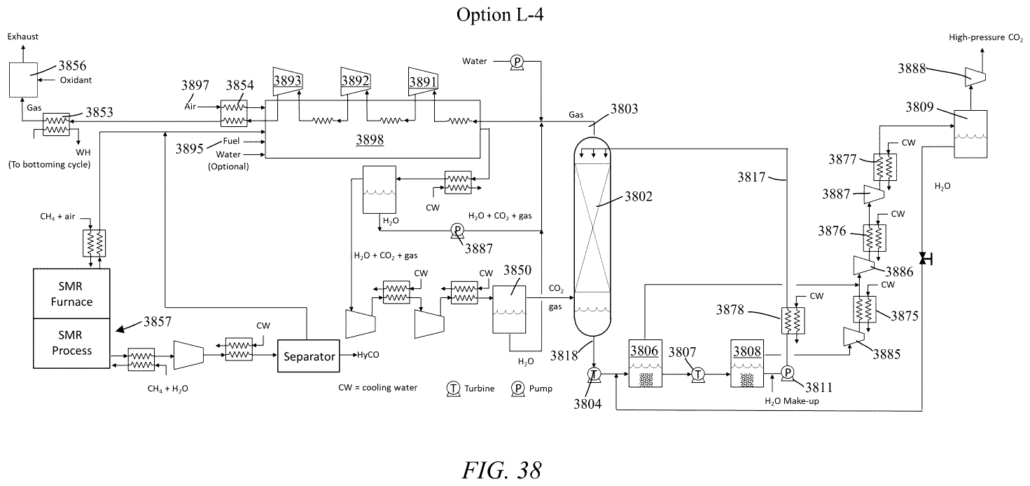

FIG. 38 shows Option L-4, according to an embodiment of the disclosure. Option L-4 is like Option L-2, except that the product gas is HyCO (primarily a mixture of hydrogen and carbon monoxide) rather than hydrogen alone. Because it can be used to synthesize many chemicals and fuels, HyCO is also called synthesis gas (syngas). To recover HyCO, there are numerous separation options (e.g., pressure swing absorption, membranes).

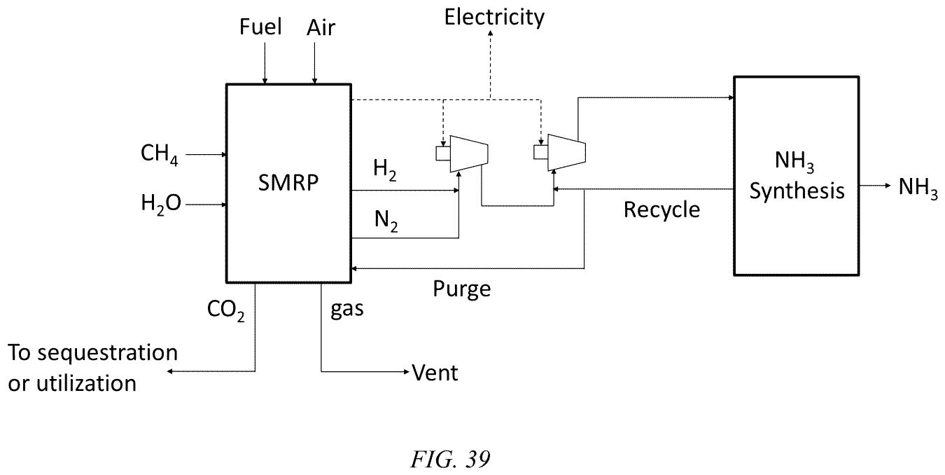

FIG. 39 shows a process that produces ammonia from hydrogen and nitrogen produced by steam methane reforming+power production (SMRP), according to an embodiment of the disclosure. For example, Options L-1 or L-2 could be used to produce hydrogen. In yet another option, a conventional SMR could be combined with a conventional power plant that employs add-on carbon capture. Regardless of the power production process, carbon dioxide is separated, which leaves a residual stream of gas that is primarily nitrogen. The nitrogen and hydrogen are compressed and used to make ammonia. Typically, the per-pass conversion in an ammonia synthesis plant is low, so the ammonia product is condensed and harvested. The uncondensed gas (primarily hydrogen and nitrogen) is recycled to the reactor, where it can react. Because the recycled gas contains small amounts of gases other than hydrogen and nitrogen, a purge stream is required. In this example, the purge stream is returned to the SMRP for further processing.

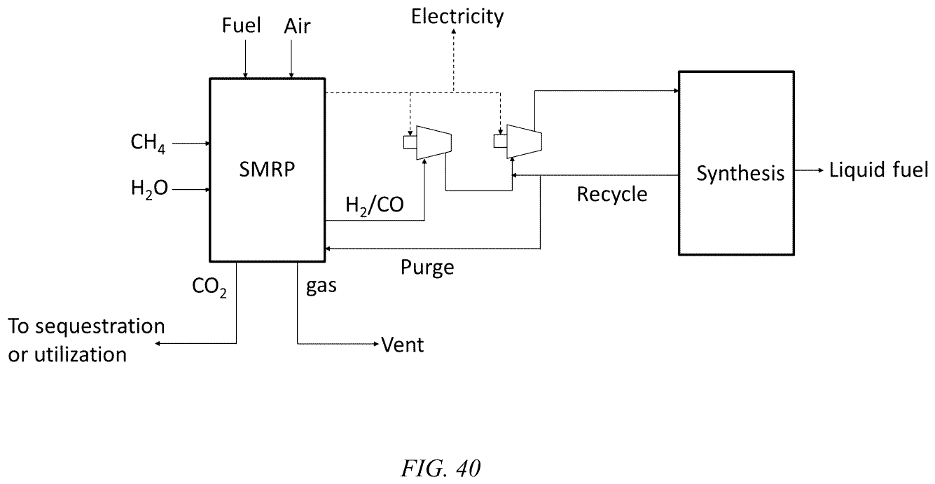

FIG. 40 shows a process that produces liquid fuels and chemicals from hydrogen and carbon monoxide produced by steam methane reforming+power production (SMRP), according to an embodiment of the disclosure. For example, Options L-3 or L-4 could be used to produce hydrogen and carbon monoxide. In yet another option, a conventional SMR could be combined with a conventional power plant that employs add-on carbon capture. Directly from the SMR, the ratio of H₂ and CO may not be correct for the synthesis of fuels and chemicals; normally, it is too rich in hydrogen. To adjust the CO:H₂ ratio, there are a number of options, such as the following examples:
Employ a separator (e.g., PSA, membrane) that removes excess hydrogen.
Operate a reverse water gas shift (RWGS) that converts CO₂ to CO.
Add CO₂ directly to the SMR, which produces CO through “dry reforming”

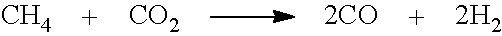

The fact that the processes described herein produce highly concentrated CO₂ is synergistic and provides opportunities for process integration.

The most common method for converting syngas is the Fischer Tropsch process; however, there are many other options, such as methanol and ethanol synthesis. In addition to liquid products, it is also possible to produce gaseous olefins, such as ethylene.

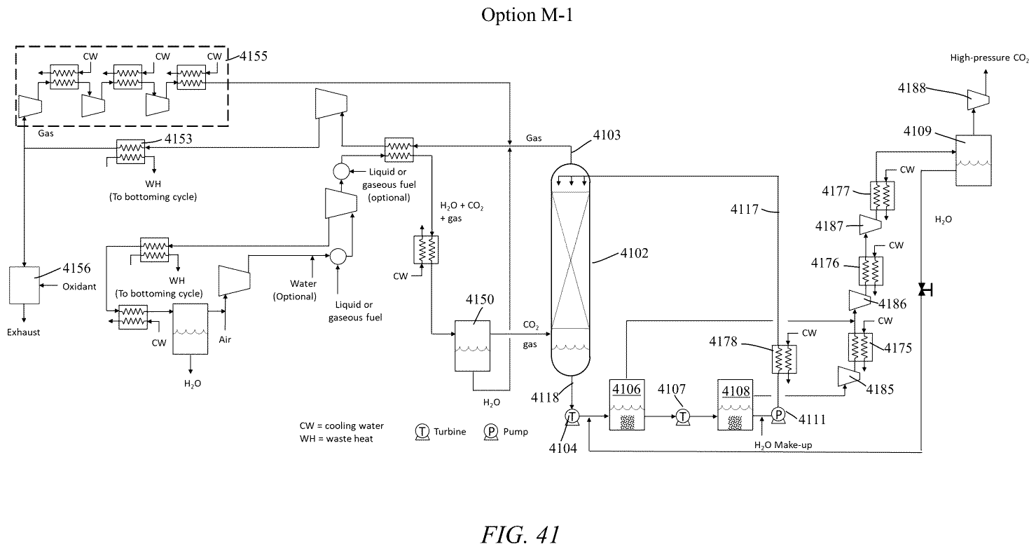

FIG. 41 shows Option M-1, according to an embodiment of the disclosure. Option M-1 employs a that employs effluent gas recirculation (EGR) to increase the CO₂ concentration in the combustion gas to near-stoichiometric levels. Without recirculation, the CO₂ concentration in the effluent gas is about 3 to 5 mol %. In contrast, with EGR, the concentration in dry gas increases to near-stoichiometric (11.7 mol % CO₂ for methane). This higher concentration greatly reduces the cost of carbon capture by increasing the partial pressure of CO₂ in the gas.

In principle, a side stream is pulled from the combustor, from which the CO2 will be removed. In practice, the operating temperature of most combustors is too high and exceeds the limits of most metals that could be employed in heat exchangers. Rather than take a side stream of gas from the combustor, FIG. 41 shows the side stream being removed from an intermediate stage in the expander. Optionally, additional fuel can be added to the side stream to ensure that the effluent from the combustor is fuel-rich and therefore provides a reducing environment that increases the maximum operating temperature of many metals that are employed in heat exchangers.

As shown in FIG. 41, the combined-cycle gas turbine does not employ a recuperator. Although this is the favored configuration in industry, a recuperator could be added to preheat the incoming air.

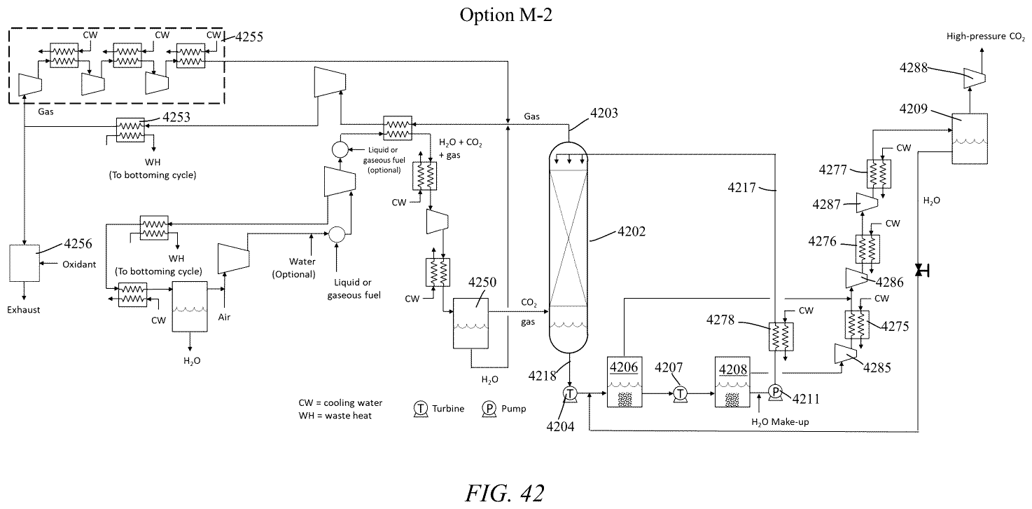

FIG. 42 shows Option M-2, according to an embodiment of the disclosure. Option M-2 is identical to Option M-1, except that an additional compression step is added prior to the absorber.

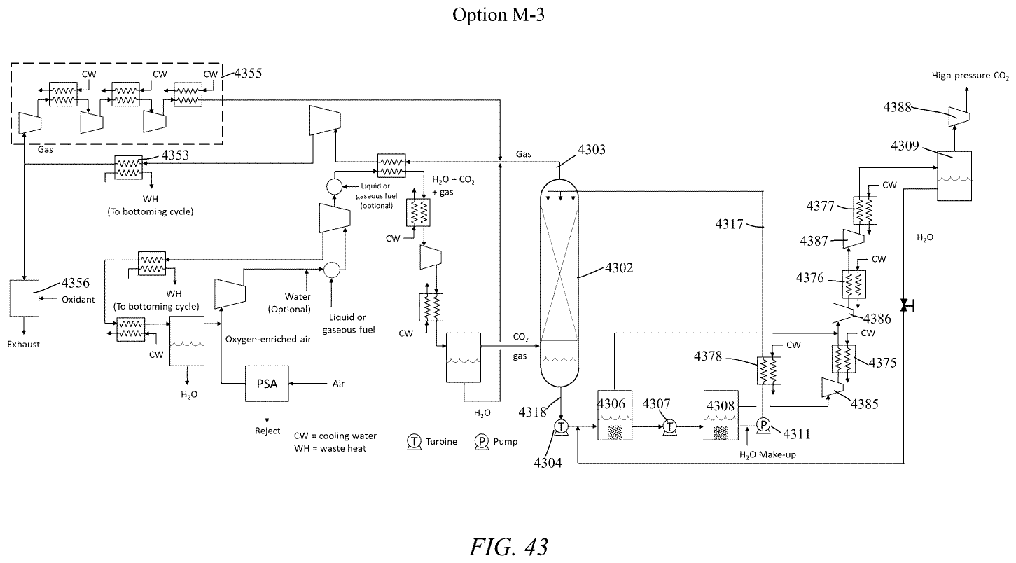

FIG. 43 shows Option M-3 in which the feed to the power plant is enriched with oxygen according to an embodiment of the disclosure. As shown, oxygen enrichment is performed with pressure-swing adsorption (PSA); however, other enrichment methods can be employed as well, such as vacuum-swing adsorption, membranes, cryogenics, addition of oxygen from water electrolysis, etc. The following are the equations that describe the stoichiometric reaction of methane (CH₄), Utah coal (CH_{0.9}O_{0.1}), and poplar biomass (CH_{1.5}O_{0.6}) with enriched air:

$$\begin{matrix}Methane & C {H}_{4} + 2 {O}_{2} + 2 \frac{100 - x}{x} {N}_{2} \to C {O}_{2} + 2 {H}_{2} O + 2 \frac{100 - x}{x} {N}_{2} \\ Coal & {CH}_{0.9} {O}_{0.1} + 1.1 \; 75 {O}_{2} + 1.175 \frac{100 - x}{x} {N}_{2} \to C {O}_{2} + 0.45 {H}_{2} O + 1.175 \frac{100 - x}{x} {N}_{2} \\ Biomass & {CH}_{1.5} {O}_{0.6} + 1.0 \; 75 {O}_{2} + 1.075 \frac{100 - x}{x} {N}_{2} \to C {O}_{2} + 0.75 {H}_{2} O + 1.075 \frac{100 - x}{x} {N}_{2}\end{matrix}$$

where x is the percentage of oxygen in the feed air. At stoichiometric conditions, the percentage of carbon dioxide in dry flue gas follows:

$$\begin{matrix}Methane & C {O}_{2} Percentage = \frac{1}{1 + 2 \frac{100 - x}{x}} \times 100 \% \\ Coal & C {O}_{2} Percentage = \frac{1}{1 + 1.175 \frac{100 - x}{x}} \times 100 \% \\ Biomass & C {O}_{2} Percentage = \frac{1}{1 + 1.075 \frac{100 - x}{x}} \times 100 \%\end{matrix}$$

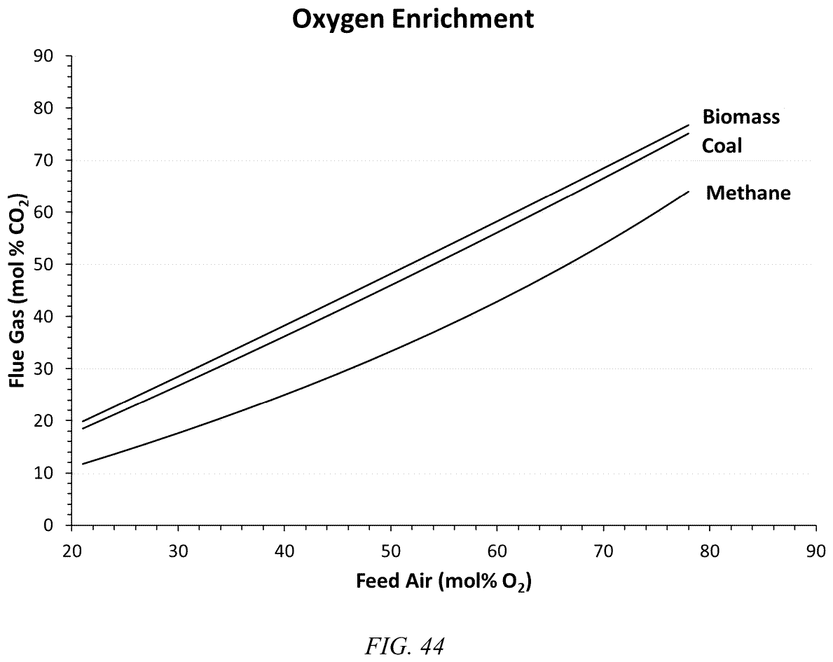

FIG. 44 shows the relationship between the percentage of carbon dioxide in dry flue gas as a function of percentage of oxygen in the feed gas.

The moles of carbon dioxide per mole of oxygen follows:

$$\begin{matrix}Methane & Ratio = \frac{1 mol {CO}_{2}}{2 mol {O}_{2}} = 0.5 \frac{mol {CO}_{2}}{mol {O}_{2}} \times \frac{44 g {CO}_{2}}{mol {CO}_{2}} \times \frac{mol {O}_{2}}{32 g {O}_{2}} = 0.688 \frac{g {CO}_{2}}{g {O}_{2}} \\ Coal & Ratio = \frac{1 mol {CO}_{2}}{1.175 mol {O}_{2}} = 0.851 \frac{mol {CO}_{2}}{mol {O}_{2}} \times \frac{44 g {CO}_{2}}{mol {CO}_{2}} \times \frac{mol {O}_{2}}{32 g {O}_{2}} = 1.170 \frac{g {CO}_{2}}{g {O}_{2}} \\ Biomass & Ratio = \frac{1 mol {CO}_{2}}{1.075 mol {O}_{2}} = 0.930 \frac{mol {CO}_{2}}{mol {O}_{2}} \times \frac{44 g {CO}_{2}}{mol {CO}_{2}} \times \frac{mol {O}_{2}}{32 g {O}_{2}} = 1.279 \frac{g {CO}_{2}}{g {O}_{2}}\end{matrix}$$

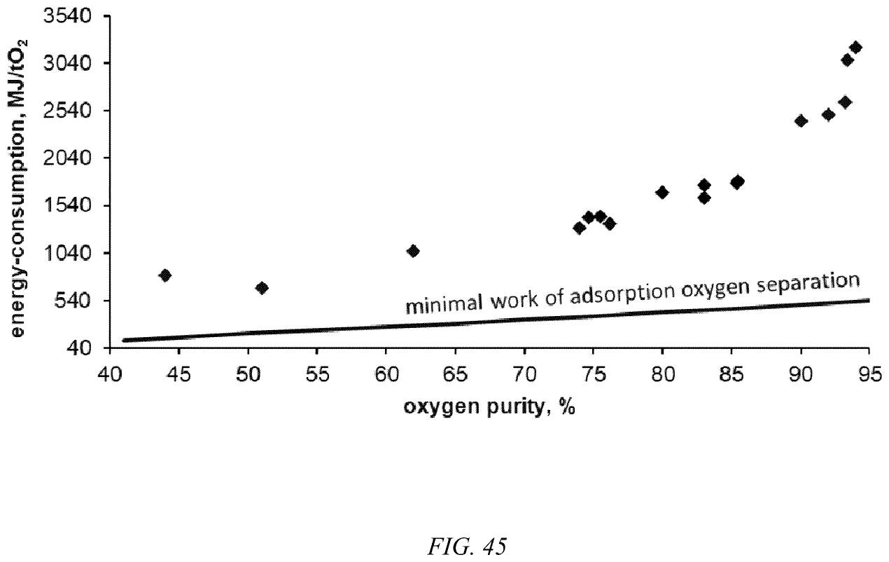

FIG. 45 shows the energy cost of increasing the oxygen concentration in air using vacuum-pressure swing adsorption. [4] For example, the energy cost of producing 51% oxygen in air is measured to be about 669 MJ/tonne O₂ (186 kWh/tonne O₂). In the case of biomass fuel, this energy consumption is 145 kWh/tonne CO₂. Assuming the grid price of electricity is $0.05/kWh, the energy cost of concentrating the oxygen is $7.27/tonne CO₂. This energy cost increases the CO₂ partial pressure by 2.4 times, which benefits the downstream CO₂ separation process by reducing both the size of equipment and energy consumption.

In the integrated processes described above, power production is combined with CO₂-recovery Option A-1. It is understood that power production could be combined with any of the other CO₂-recovery options.

### Operating Conditions

The table below is the operating conditions applicable to the embodiments described. While specific broad, medium, and narrow ranges have been supplied, others may alternatively be used in yet other embodiments.

| | Broad | Medium | Narrow |
|---|---|---|---|
| Absorber temperature (° C.) | −40 to 50 | −30 to 40 | −10 to 30 |
| Absorber pressure (bar) | 5 to 200 | 10 to 100 | 15 to 60 |
| Desorber temperature (° C.) | 0 to 150 | 5 to 100 | 10 to 60 |
| Desorber pressure (bar) | 0.03 to 30 | 0.03 to 5 | 0.03 to 2 |
| Combustor temperature (° C.) | 400 to 2000 | 500 to 1900 | 600 to 1800 |
| Combustor pressure (bar) | 1 to 200 | 1 to 100 | 1 to 60 |
| Heat recovery temperature (° C.) | 25 to 1300 | 25 to 1200 | 25 to 1100 |
| Heat recovery pressure (bar) | 1 to 200 | 1 to 100 | 1 to 60 |
| Waste heat temperature (° C.) | 25 to 700 | 30 to 700 | 35 to 700 |

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method of performing work on a load, the method comprising:
combusting a fuel containing carbon and an oxidant in a combustion device to form gaseous combustion products having a temperature and a pressure;
adjusting at least one of the temperature and the pressure of the gaseous combustion products to a level suitable for separating the gaseous combustion products;
separating the gaseous combustion products into a carbon dioxide-rich stream and a carbon dioxide-poor stream, the carbon dioxide-poor stream having a temperature and a pressure;
heating the carbon dioxide-poor stream to a temperature suitable for expanding the carbon dioxide-poor stream against a load; and
expanding the carbon dioxide-poor stream against the load.

2. The method of claim 1, wherein adjusting at least one of the temperature and the pressure comprises cooling the gaseous combustion products to a temperature suitable for separating the gaseous combustion products into the carbon dioxide-rich stream and the carbon dioxide-poor stream.

3. The method of claim 1, wherein adjusting at least one of the temperature and the pressure comprises compressing the gaseous combustion products to a pressure suitable for separating the gaseous combustion products into the carbon dioxide-rich stream and the carbon dioxide-poor stream.

4. The method of claim 1, wherein the gaseous combustion products are cooled by heat exchange against at least one of the carbon dioxide-rich stream and the carbon dioxide-poor stream.

5. The method of claim 4, wherein the heat exchange occurs within the combustion device.

6. The method of claim 1, wherein at least one of the oxidant and the fuel is heated by heat exchange against an expanded gas resulting from expanding the carbon dioxide-poor stream.

7. The method of claim 1, wherein the fuel is coal, biomass, or a gaseous fuel.

8. The method of claim 1, wherein the gaseous combustion products are cooled against a second gas having a pressure suitable for expansion against a load, whereby the second gas is heated to a temperature suitable for expansion against the load and is expanded against the load.

9. The method of claim 1, wherein the oxidant contains carbon.

10. The method of claim 9, wherein the oxidant comprises effluent from a combustion-fired furnace, a heat engine, a cement kiln, an electric arc furnace, a paper mill, pulp production, a steam methane reformer, or a combustion-fired boiler.

11. The method of claim 1, wherein the fuel contains oxides of carbon.

12. The method of claim 11, wherein the fuel contains carbon dioxide.

13. The method of claim 11, wherein the fuel comprises effluent from a blast furnace, an oil refinery, a steam methane reformer, a chemical production process, an anaerobic digester, a landfill, or a treatment plant.

14. The method of claim 1, wherein separating the gaseous combustion products comprises dissolving carbon dioxide in a solvent.

15. The method of claim 14, wherein the solvent is one of water or methanol.

16. The method of claim 14, wherein the solvent is water.

17. A heat engine comprising:
a compressor configured to compress at least one of an oxidant inducted into the heat engine and gaseous combustion products;
a combustion device configured to combust the oxidant with a fuel containing carbon to create the gaseous combustion products containing carbon dioxide;
a carbon dioxide separator configured to separate the gaseous combustion products to create a carbon dioxide-rich stream and a carbon dioxide-poor stream; and
an expander configured to expand the carbon dioxide-poor stream.

18. The heat engine of claim 17, further comprising a cooling device configured to cool the gaseous combustion products.

19. The heat engine of claim 17, further comprising a heating device configured to heat at least one of the carbon dioxide-poor stream and the carbon dioxide-rich stream.

20. The heat engine of claim 17, further comprising a heat exchanger configured to transfer heat from an expanded stream resulting from the expander to at least one of the oxidant and the fuel.

21. A method of performing work on a load, the method comprising:
cooling an effluent from a first process, the effluent having a first pressure and a first temperature greater than 150° C., to a second temperature less than the first temperature;
compressing the cooled effluent to a second pressure greater than the first pressure to create an expansion gas;
reheating the expansion gas against the effluent; and
expanding the reheated expansion gas against the load.

22. The method of claim 21, wherein the first temperature is greater than 250° C.

23. The method of claim 21, wherein the expansion gas is separated into a carbon dioxide-rich gas and a carbon dioxide-poor gas, and the carbon dioxide-poor gas is heated against the effluent and expanded against the load.

24. The method of claim 23, wherein the separation is performed by absorbing carbon dioxide into a solvent.

25. The method of claim 24, wherein the solvent is at least one of water, an aqueous solution, Rectisol, Selexol, or potassium carbonate.

26. The method of claim 21, wherein the second pressure is greater than 40 bar.
